(19) United States
(12) Patent Application Publication
(10) Pub. No.: US 2014/0356845 A1
(43) Pub. Date: Dec. 4, 2014

(54) SYSTEM AND METHOD FOR DISTRIBUTED ONLINE EDUCATION

(71) Applicant: Anvoy, Inc., Francesville, IN (US)

(72) Inventor: Robert Huber, Francesville, IN (US)

(21) Appl. No.: 14/362,189

(22) PCT Filed: Dec. 10, 2012
(86) PCT No.: PCT/US12/68788

§ 371 Date: Jun. 2, 2014

Related U.S. Application Data
(60) Provisional application No. 61/630,300, filed on Dec. 8, 2011.
(60) Provisional application No. 61/654,683, filed on Jun. 1, 2012.

(51) Int. Cl. G09B 5/12

(52) U.S. Cl. CPC G09B 5/12
USPC 434/362

(57) ABSTRACT

A method for online distributed education comprising, receiving a course materials from a teacher at a processor, publishing a course based on the course materials to a plurality of students using the processor, receiving at least one registration from a first student in the plurality of students to the course at the processor, publishing a customized course experience to the first student using the processor, the first student completing the course, and the first student teaching the course to at least one student in the plurality of students.

### CROSS REFERENCE TO RELATED APPLICATION

This patent application claims the benefit of and incorporates by reference herein the disclosure of the pending provisional application U.S. Ser. No. 61/654,683, filed Jun. 1, 2012 and pending provisional application U.S. Ser. No. 61/630,300, filed Dec. 8, 2011.

### BACKGROUND

The traditional education model relies on outdated principles that have not kept up with modern needs in the global economy. Specifically, as education costs increase, quality of education decreases and many specialized jobs are left unfilled. For example, the influx of retirees in the baby boomer generation will leave a gap in employment as there are few qualified candidates to fill the retirees' specialized roles. The current one-size-fits-all education model is hundreds of years old. It was designed to mass produce robotic workers for the Industrial Revolution, when factories needed large numbers of identical, conforming people to fill static roles. Today, many of those factories are gone, and most of those that remain use real robots. We are now in the Information Age and available jobs require more independent, individual, creative thinkers. Since the traditional education model is not designed to produce this type of employee, there exists a need for a system and method for distributed online education that is designed to produce independent, individual, creative thinkers.

The chances that current students will stay in one job for an entire career are slim. The jobs that most current students will have may not even exist yet. Future workers could have as many as 15 different jobs during their lifespan. Going forward we need a way to stay ahead of the curve, to continue learning and adapting to new job opportunities as they become available.

Given the declining quality and increasing cost of education, the concept of a brick-and-mortar education system relying on buildings, campuses, bus fleets, and administrative bureaucracies is no longer the most efficient system available. The supplement of e-books in the classroom, online courses offered through universities, and entire e-learning degrees available online evidences the declining need of a brick-and-mortar institution. The natural replacement to the brick-and-mortar institution is an e-learning experience available on the Internet. The e-learning experience provides for greater efficiencies, an on-demand approach, and many benefits over the traditional brick-and-mortar approach. As such, the brick-and-mortar system is on the decline while the e-learning experience is rapidly expanding.

Nevertheless, motivating students through an e-learning experience provides many challenges. In a brick-and-mortar classroom, a teacher has direct and physical interaction with students in a way that lessens the impact of student apathy. If a student is not paying attention, acting up, or generally not learning the material, the teacher is able to provide immediate feedback to the student or cater the lesson specifically towards a student that is struggling. In e-learning, such physical interaction is unavailable and often times students review pre-recorded lectures without any involvement from a teacher. In a traditional e-learning environment, if a student is not learning the material, the teacher may not be aware of the fact until it is too late to help the student. Although the e-learning industry is growing rapidly, the issue of student motivation and lack of direct feedback in e-learning precludes the industry from achieving its maximum potential.

Accordingly, there exists a need for a system and method for distributed online education that provides incentives to those involved in the classroom to remove the issue of student apathy while also providing for direct feedback and communication between the teacher and student.

No single entity can produce solutions as good as a large number of independent, private laboratories can. Accordingly, there exists a need for a system and method for distributed online education that allows a large number of education providers to collaborate and compete with each other in order to foster more innovation, change and progress.

Learning takes place at different levels. The lowest level is Recognition, which is the ability to identify written words, spoken language, historical facts or mathematical answers. The second level is Comprehension, which is not only recognizing a series of words, but also understanding what message they convey. The third level is Assimilation, which is applying knowledge. The forth level, Persuasion, is helping others to understand and apply knowledge, and the last and highest level of learning is not just persuading others, but teaching others to persuade others. Traditional schools and education methods are struggling to teach even the lower levels of learning. Many graduates still have difficulty processing information. They can read a sentence but can't put the message into their own words. They can do a math problem, but can't explain what the solution represents. Therefore, there exists a need for a system and method for distributed online education that is designed to teach higher levels of learning.

Standardized education inherently tends to prevent the autonomy that is the single most important learning motivator. Accordingly, there exists a need for a system and method for distributed online education that allows students to explore and discover for themselves, which is how we naturally learn.

Multiple Choice (MC) testing forces students to think “in a box” instead of “out of the box.” MC seems to suppress the potential of a student by gradually decreasing their creativity and critical thinking over time. Accordingly, there exists a need for a system and method for distributed online education based on open-ended questions, human interaction, and human validation that is only limited by the imagination.

Diplomas and paper transcripts are based on technology that is centuries old. They can only show a “snap-shot in time.” They present what was accomplished 5, 10 or 20 years ago, but not what has been accomplished since. Accordingly, there exists a need for a system and method for distributed online education that provides a qualified, chronological, searchable, digital record of not only student grades, but also the results of how the student applied and used what was learned over time.

Standardized education tends to limit smarter students to the pace of the slowest students. This slow pace causes brighter students to become bored and discouraged. Accordingly, there exists a need for a system and method for distributed online education that lets students learn as fast or as slow as they want.

School students have to wait days for feedback on assignments, weeks for class grades, and months to start new courses. It takes years before they find out if they can make money with what they learned. Accordingly, there exists a need for a system and method for distributed online education that dramatically shortens the learning cycle and lets students see results right away.

Many people worldwide cannot afford higher education. Accordingly, there exists a need for a system and method for distributed online education that helps remove this financial barrier to self-improvement.

Many parents are concerned that existing public education systems do not honor their individual religious or moral convictions. Accordingly, there exists a need for a system and method for distributed online education that can be easily tailored to respect the religious or moral convictions of the individual.

### BRIEF DESCRIPTION OF THE DRAWINGS

The features and advantages of this disclosure, and the manner of attaining them, will be more apparent and better understood by reference to the accompanying drawings, wherein:

FIG. 1A depicts aspects of a model for distributed online education according to at least one embodiment of the present disclosure.

FIG. 1B depicts a method for distributed online education according to at least one embodiment of the present disclosure.

FIG. 1C depicts a method for distributed online education according to at least one embodiment of the present disclosure.

FIG. 1D depicts a method for distributed online education according to at least one embodiment of the present disclosure.

FIG. 1E depicts a method for distributed online education according to at least one embodiment of the present disclosure.

FIG. 1F depicts a method for distributed online education according to at least one embodiment of the present disclosure.

FIG. 1G depicts aspects of a model for distributed online education according to at least one embodiment of the present disclosure.

FIG. 2A depicts aspects of a method for distributed online education according to at least one embodiment of the present disclosure.

FIG. 2B depicts aspects of a method for distributed online education according to at least one embodiment of the present disclosure.

FIG. 3A depicts a system for distributed online education according to at least one embodiment of the present disclosure.

FIG. 3B depicts a point in time representation of a graphical-user interface in a system for distributed online education according to at least one embodiment of the present disclosure.

FIG. 3C depicts a method for distributed online education according to at least one embodiment of the present disclosure.

FIG. 4A depicts a system and method for distributed online education according to at least one embodiment of the present disclosure.

FIG. 4B depicts a point in time representation of a graphical-user interface in a system for distributed online education according to at least one embodiment of the present disclosure.

FIG. 4C depicts a point in time representation of a graphical-user interface in a system for distributed online education according to at least one embodiment of the present disclosure.

FIG. 5 depicts a flowchart representing a method for distributed online education according to at least one embodiment of the present disclosure.

FIG. 6A depicts a flowchart representing a method for distributed online education according to at least one embodiment of the present disclosure.

FIG. 6B depicts a model for distributed online education according to at least one embodiment of the present disclosure.

FIG. 6C depicts a flowchart representing a method for distributed online education according to at least one embodiment of the present disclosure.

FIG. 6D depicts a point in time representation of a graphical-user interface in a system for distributed online education according to at least one embodiment of the present disclosure.

FIG. 7A depicts a system for distributed online education according to at least one embodiment of the present disclosure.

FIG. 7B depicts a system for distributed online education according to at least one embodiment of the present disclosure.

FIG. 7C depicts a system for distributed online education according to at least one embodiment of the present disclosure.

FIG. 7D depicts a system for distributed online education according to at least one embodiment of the present disclosure.

FIG. 7E depicts a system for distributed online education according to at least one embodiment of the present disclosure.

FIG. 8 depicts a system for distributed online education according to at least one embodiment of the present disclosure.

FIG. 9A depicts a system for distributed online education according to at least one embodiment of the present disclosure.

FIG. 9B depicts a system for distributed online education according to at least one embodiment of the present disclosure.

FIG. 10A depicts a method for distributed online education according to at least one embodiment of the present disclosure.

FIG. 10B depicts a system for distributed online education according to at least one embodiment of the present disclosure.

FIG. 10C depicts a system for distributed online education according to at least one embodiment of the present disclosure.

FIG. 10D depicts a system for distributed online education according to at least one embodiment of the present disclosure.

FIG. 10E depicts a model for distributed online education according to at least one embodiment of the present disclosure.

FIG. 11 depicts a model for distributed online education according to at least one embodiment of the present disclosure.

FIG. 12A depicts a model for distributed online education according to at least one embodiment of the present disclosure.

FIG. 12B depicts a model for distributed online education according to at least one embodiment of the present disclosure.

FIG. 12C depicts a model for distributed online education according to at least one embodiment of the present disclosure.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one of ordinary skill in the art to which this disclosure pertains.

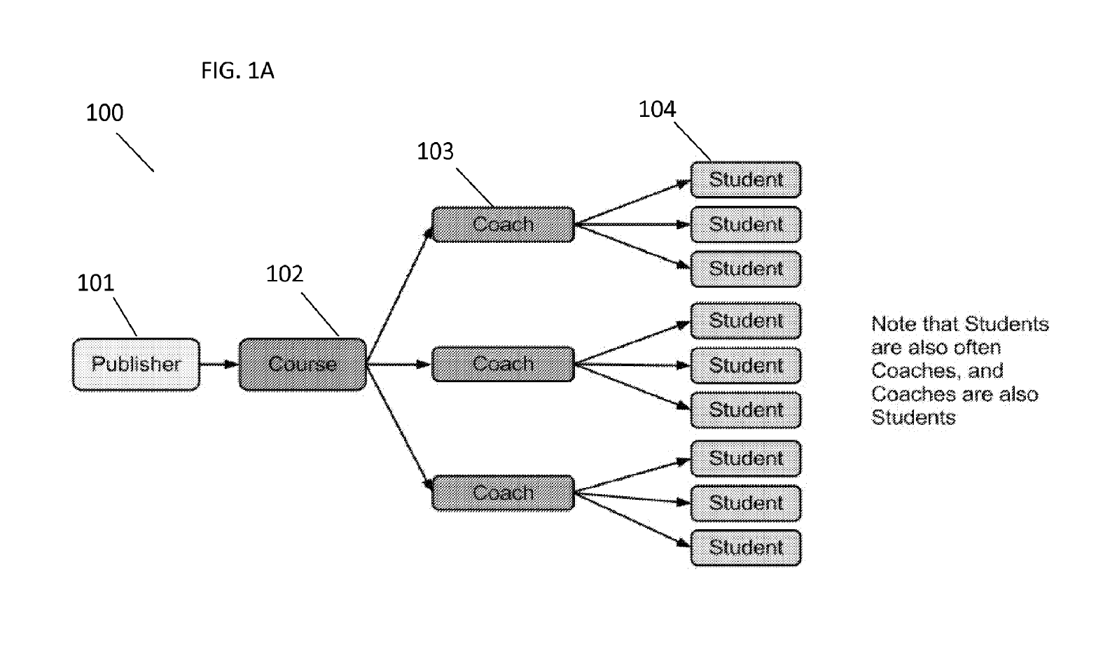

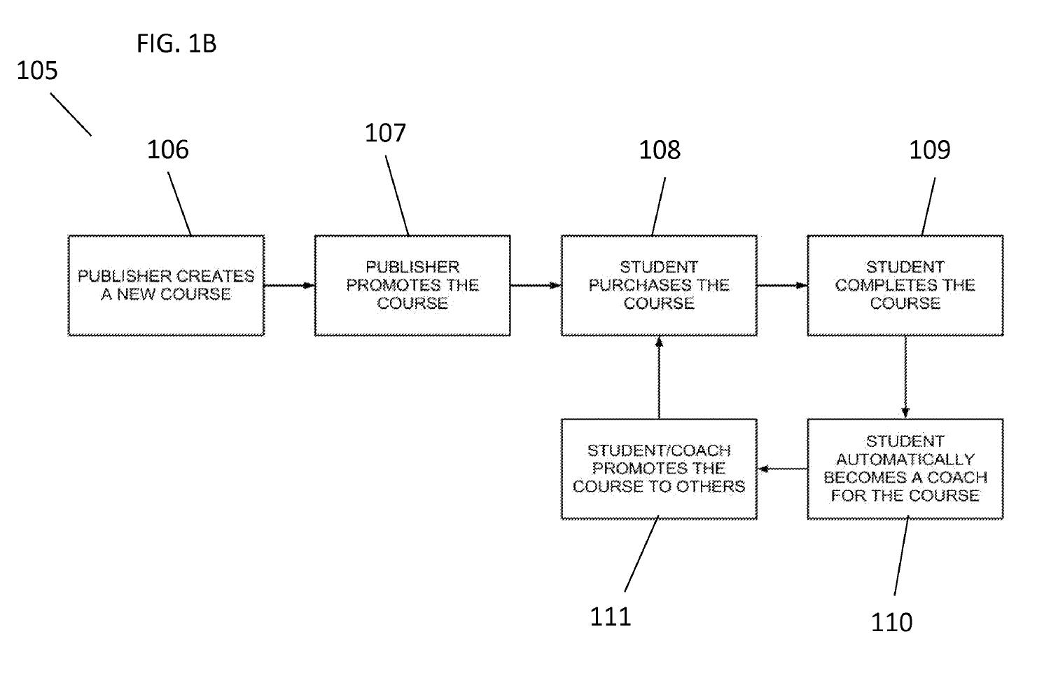

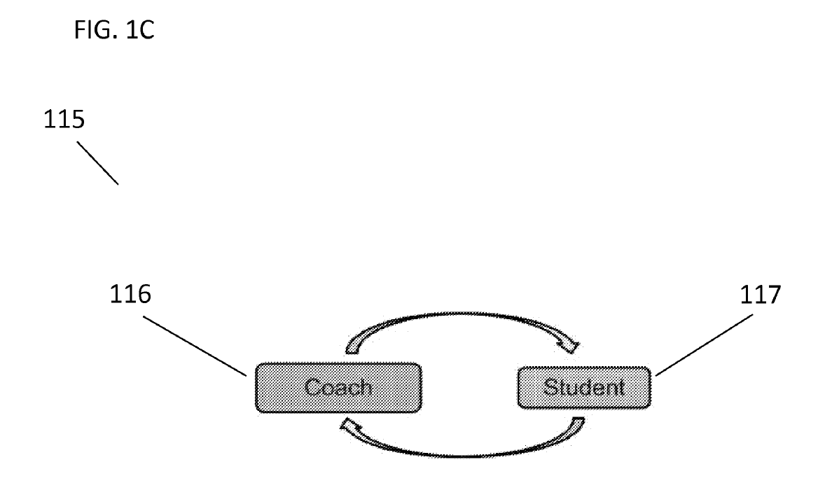

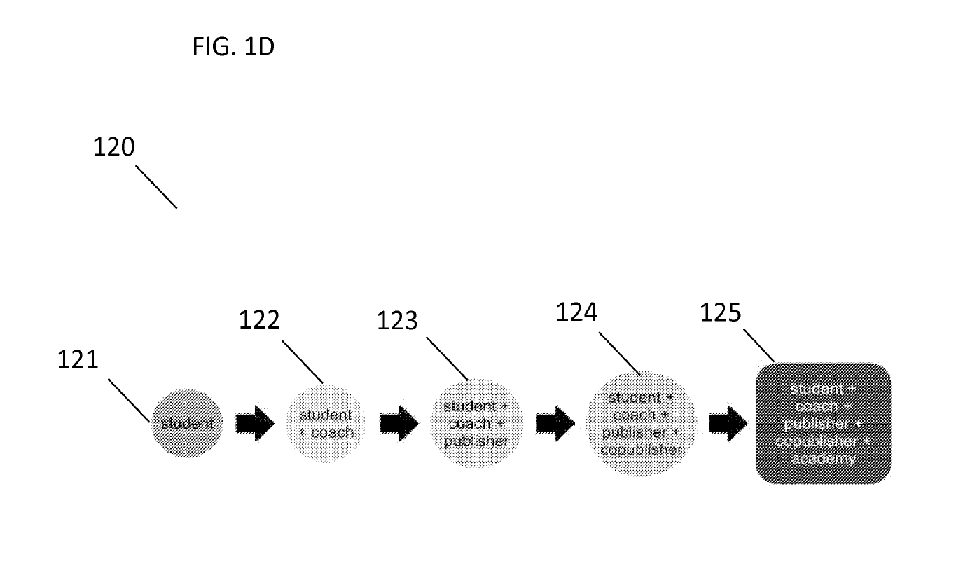

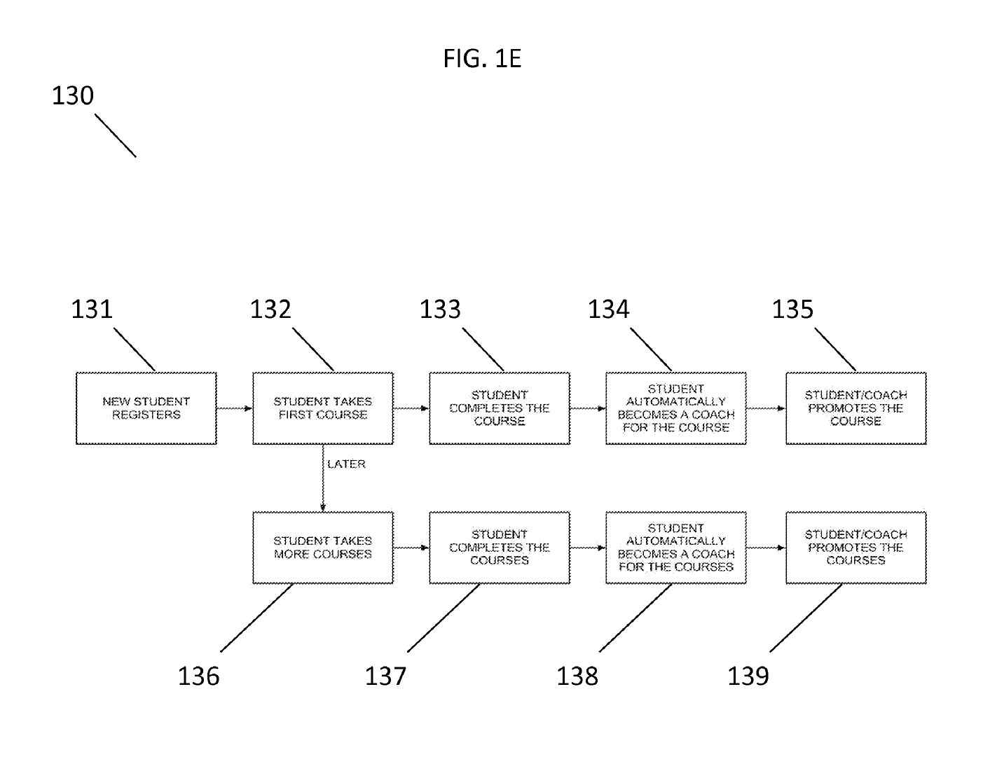

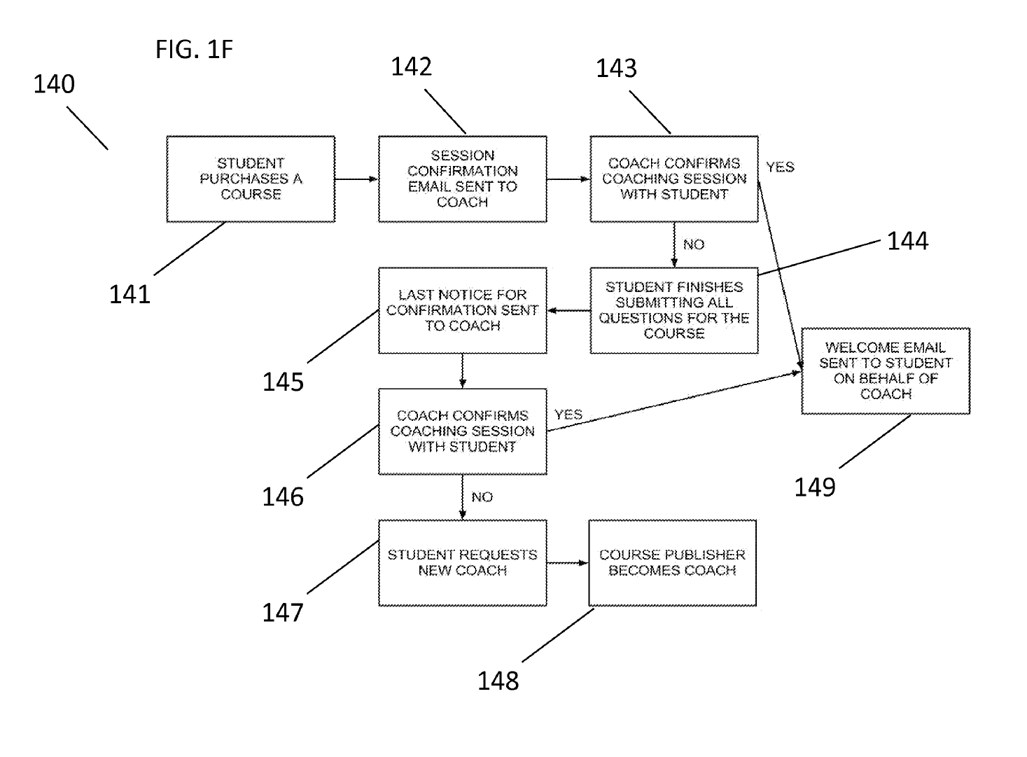

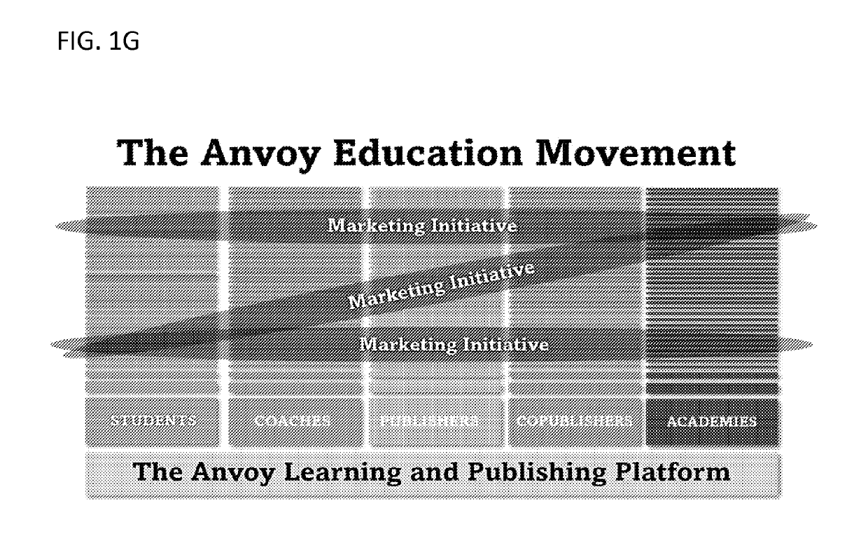

Referring now to FIG. 1A, a model for distributed online education is shown according to at least one embodiment of the present disclosure. As shown in FIG. 1A, a distributed online education model 100 according to at least one embodiment of the present disclosure includes a Publisher 101, at least one course 102, one or more Coaches 103, and one or more Students 104. As described further herein, in at least one embodiment of the present disclosure, a Publisher 101 creates a Course 102. In such an embodiment, as Students 104 complete the Course 102, Students 104 becomes Coaches 103. Then, in such an embodiment, Coaches 103 teach additional Students 104. In such an embodiment, the model 100 creates an exponentially growing learning experience where Coaches 103 teach Students 104. In an exemplary embodiment, a Coach 103 is a peer learner having grown in the learning process from a Student. In such an embodiment, the Coach 103 is also a Student who is learning alongside and assisting other Students 104 in the learning process. In an exemplary embodiment, the Coach 103 and Student 104 relationship exists in every Course 102 such that all Courses 102 are coached meaning that Students 104 work through each Course 102 with the help of a Coach 103 who has already completed that Course 102.

Referring now to FIG. 1B, it is shown a method for distributed online education is described in the present disclosure. FIG. 1B shows a method 105 for distributed online education according to at least one embodiment of the present disclosure. As shown in FIG. 1A, the method 105 includes a Publisher creating a new course at step 106, the Publisher promoting the course at step 107, a Student purchasing the course at step 108, the Student completing the course at step 109, the Student becoming a Coach at step 110, the Coach promoting the course to others in step 111.

In at least one embodiment of the present disclosure, the method 105 includes a Publisher who creates a set of coursework and learning opportunities in a Course in step 106. In at least one embodiment of the present disclosure, the method 105 also includes a type of coaching or approach to learning where a teacher or Publisher not only teaches a Student a Course, but also teaches the Student how to teach the Course to others. It should be appreciated that in this approach the knowledge is further spread by the Student teaching the course and teaching how to teach the course to other Students.

A Publisher may include, but is not limited to, a person with expertise, learning opportunities, or knowledge about a specific subject in which the Publisher intends to teach. In an exemplary embodiment of the present disclosure, a Publisher registers and creates a Course in an e-learning system in step 106 with the intent to provide knowledge to a user base. In such an embodiment, the e-learning system may include a web-based portal available on the Internet. It should be appreciated that the Publisher may possess knowledge in a variety of subjects, such as, for example, plumbing, crafting, singing, developing software, or any subject that can be taught. Further, it should be appreciated that the Publisher may possess knowledge in a variety of subjects and may intend to provide learning opportunities in multiple subjects.

In at least one embodiment of the present disclosure, a Publisher organizes her expertise and/or learning opportunities into Courses at step 106. It should be appreciated that a Course may be single, or multiple courses, or an expansive set of coursework, organized into a Study Track, depending on the expertise and desires of the Publisher creating the Course. It should be appreciated that a Course may, but is not required to prepare a Student for a specific trade skill, certification examination, undergraduate degree, associate's degree, or any educational milestone.

In one example, a Publisher registers with an e-learning system with the intent to create and distribute coursework to a community, and the Publisher creates one or more Courses with various courses offered on the e-learning site to the community in step 106. In such an example, the courses offered by the Publisher may include a preparatory coursework for the Standardized Achievement Test Series (SAT 10) at the high school level. In such an example, the Publisher creates a first course designed to improve a Student's reading comprehension and a second course designed to prepare a Student to identify and complete analogies in step 106.

As shown in the model in FIG. 1A, the Publisher is the first Coach for a new course. In at least one embodiment of the present disclosure, by publishing a course, the Publisher intends to teach the course and have the course taught to a community of Coaches and Students. Referring now to FIG. 1B, the Publisher promotes the course in step 107. By promoting the course in step 107, the Publisher may offer to teach the course. The Publisher may promote the course in step 107 through a variety of ways, such as, for example, by publishing the course in an online education portal, by posting about the course on the Publisher's social media page, by emailing potential persons interested in taking the course, and other ways. It should be appreciated that it is within the scope of the present disclosure for the Publisher to only promote the course in step 107 by publishing the course to an online education portal.

In at least one embodiment of the present disclosure, a Student purchases the course in step 108. The Student may purchase the course in the step 108 by responding to the Publisher's promotions in step 107. For example, the Student may purchase the course in step 108 by registering to an online education portal and purchasing the course therein. In another example, the Student may purchase the course in step 107 by paying the Publisher directly for the course. It should be appreciated that it is within the scope of the present disclosure for the Student to purchase the course in any way.

In at least one embodiment of the present disclosure, the Course is followed by Students who learn the coursework directly from the Publisher in step 108. In at least one embodiment of the present disclosure, the Student successfully completes the course in step 109. Taking and completing the course in step 109 may include, but is not limited to, registering to an online education portal, attending lectures put on by the Publisher, interacting with the Publisher in an online video environment or chat environment, or corresponding with the Publisher to learn the materials taught through the course.

In at least one embodiment of the present disclosure, Students sign up for the Publisher's courses and complete such courses through one on one involvement between the Publisher and the Student in step 108. Further, at the completion of the course, the Student is enabled to become a Coach in order to teach future Students the same completed course in step 110. In such an example, a Student successfully completing the first course designed to improve a Student's reading comprehension from the Publisher may choose to become a Coach and offer to teach the same course to other Students in step 111. Nevertheless, it should be appreciated that a Student is not required to become a Coach and may choose to simply take a course or set of coursework without intending to teach the course or set of coursework to other Students along the Course. It should be appreciated that it is within the scope of the present disclosure for the Student only to be offered to become a Coach in the event that the Student achieves an acceptable grade within the course, such as, for example, a passing grade, achieving a threshold percentage of correct answers, and/or falling into a top percentage of Student scores with such threshold being defined by the Publisher. In an exemplary embodiment, any Student who completes a course may become a Coach for the completed course. It should be appreciated that allowing Students to become a Coach enables the Student to continue learning while coaching other Students.

In at least one embodiment of the present disclosure, Students completing courses in step 109 are expected to become Coaches themselves, because teaching others via coaching is an integral and beneficial part of the overall learning process. In at least one embodiment of the present disclosure, the Course is further distributed as Students are enabled to become Coaches on the Course, thereby allowing such Coaches to promote the Course by teaching the same material to new Students in step 110. It should be appreciated that by enabling Students to become Coaches, the number of persons able to teach and be taught the course will increase exponentially as described in the model depicted in FIG. 1A. It should be appreciated that the method 105 incentivizes Students by enabling such Students to become Coaches, which further allows the Student to profit from and/or share the coursework with other Students. It should be appreciated that the method 105 enables every Student to become a teacher or Coach and, therefore, continuing the cycle. As such, in at least one embodiment of the present disclosure, the method 105 enables a course or set of coursework to be distributed to a large Student base in a quicker way and with more direct involvement than a typical brick-and-mortar education system by building Coach and Student relationships in an e-learning environment.

In at least one embodiment of the present disclosure, the Student automatically becomes a Coach after completion of the course in step 110. In such an embodiment, the new Coach also begins to promote the course in step 111. Then, the cycle repeats itself of steps 108, 109, 110, and 111 where a new Student purchases the course to be taught by the new Coach. It should be appreciated that this loop may continue any number of times to allow new Coaches and new Students to teach and learn the course together. It should be appreciated that it is within the scope of the present disclosure for a Coach to teach multiple Students and for multiple Students to become Coaches.

In at least one embodiment of the present disclosure, the Student completes the course through an online e-learning application. In such an embodiment, upon completion of the course, the e-learning application automatically enables the Student to become a Coach by adding Coaching functionality to the application. For example, according to at least one embodiment of the present disclosure, upon completion of the course, the e-learning application may enable functionality allowing the Student to advertise services as a Coach for the course, view dashboards associated with Coaching, and other Coaching features available on the e-learning application.

In at least one embodiment of the present disclosure, Coaches offer to teach courses to new Students in step 111. It should be appreciated that each Coach may teach multiple Students in any course or subject that the Coach learned previously from the Publisher or another coach. It should be appreciated that the Students may, in turn, become Coaches at the end of completing a course and further the Course by repeating step 111 with the new Coaches teaching courses to a new set of Students.

In one example, the Publisher teaches a Student in a preparatory course for the SAT 10 test in reading comprehension at step 108. In this example, after successful completion of the reading comprehension course by the Student in step 109, the Student chooses to become a Coach and further the Course in step 110. In this example, the Coach offers to teach the reading comprehension course to a new set of Students in step 111. After purchase of the course by a new Student in step 108 and successful completion of the reading comprehension course by the new Student in step 109, the Student may choose to further the Course by becoming a Coach and teaching the reading comprehension course to new Students in step 110. Thus, the steps 108, 109, 110, and 111 of the method 105 are repeated as Students become Coaches who teach new Students.

In at least one embodiment of the present disclosure, a Coach may be automatically assigned to a Student taking a course or be selected as a default Coach for a particular course. To populate a default Coach, an e-learning application may select from a group of available Coaches, such as, for example, by selecting the Coach based on which Coach promoted the course to the Student, by determining whether any previous Coach relationships existed between the Student and list of available Coaches, assign a Coach based on which Coach has the highest feedback for course, and/or try to select a Coach that fits the Student's demographic information.

If the course profile was opened via a promotional URL that specifies the coach, then the system uses the specified coach. For example, upon finishing a course, the system creates a special URL that specifies the new coach as the coach, so that the new coach can share the URL with her friends and they can take the course with the new coach.

Referring now to FIG. 1C, it is shown a method 115 for distributed online education according to at least one embodiment of the present disclosure. As shown in FIG. 1C, in at least one embodiment of the present disclosure, courses offered from a Publisher or Coach encourage a one on one relationship between the Coach 116 and the Student 117. In an exemplary embodiment of the present disclosure, the Coach and Student interact through a collaborative environment available through an e-learning website on the Internet. In such an embodiment, the Coach and Student may interact synchronously in real time or near real time communications, such as, for example, Internet chat, voice communications, and video and voice communications. In another embodiment, the Coach and Student may communicate through asynchronous communications, such as, for example, forum postings, email, social media, and/or text messaging.

In at least one embodiment of the present disclosure, the Coach and Student interact through collaborative environments provided by third parties available on the Internet, such as, for example, Skype, Google Docs, Facebook, and/or any online collaboration tool that allows one on one communication between people in the method 115. In such an embodiment, the direct interaction between the Coach and Student creates real-time or asynchronous collaboration. In an exemplary embodiment, the Coach and Student interact through an e-learning application in a shared learning environment available through the Internet in a Software as a Service (SaaS) model.

It should be appreciated that the interaction between the Coach and the Student provides learning opportunities in the course material for both the Coach and the Student. For example, the Coach gains a better understanding of the course material by teaching such course material to the Student, and the Student learns the course material directly from the Coach. In this example, the one on one relationship between the Coach and the Student encourages a collaborative approach to learning which allows both the Coach and Student to dig deeper into the course material. In at least one embodiment of the present disclosure, the transition of Student to Coach is integral to the learning process of the course material. In such an embodiment, the Coach gains a deeper understanding of the course material through repetition of the course material, application of the course material, and teaching the course material to another Student.

In at least one embodiment of the present disclosure, the collaboration between the Coach and Student may be monitored by an e-learning application for distribution to the Student's parents. In such an embodiment, the e-learning application includes parental controls, such as, for example, a language filter, a time limit per day for use on the e-learning application, and a subject monitor that notifies the parents in the event the Student engages in conversation that the parents have deemed inappropriate. In one example, the e-learning application monitors conversations between the Student and Coach for subject matter concerning drugs by analyzing the conversations to look for keywords, phrases, or regular expressions associated with drug activity. In this example, the e-learning application alerts the parents in the event that the keywords, phrases, or regular expressions are matched upon for drug activity. In another example, the parents set a time limit for the Student to be on the e-learning application. In the event the Student exceeds the time limit for the e-learning application, the e-learning application alerts the parents. In another example, the e-learning application may force the Student to logout of the e-learning application in the event that the Student exceeds the time limit.

Referring now to FIG. 1D, it is shown a method for distributed online education according to at least one embodiment of the present disclosure. In such an embodiment, the method 120 showing the progression of a person throughout the person's learning process starts with the person acting as a Student 121, the person becoming a Coach 122, the person becoming a Publisher 123, the person becoming a Copublisher 124, and the person starting an independent Academy 125. It should be appreciated that the method 120 may be enabled through an e-learning application that facilitates the advancement of a person in a manner that incentivizes the person to progress through each step in the method 120. In at least one embodiment of the present disclosure, in the step of the person acting as a Student 121, the person learns from Coaches, Publishers, Copublishers, and other members of an e-learning application in one or more courses. In at least one embodiment of the present disclosure, upon successfully completing one or more courses, the person may choose to become a Coach in step 122. In at least one embodiment of the present disclosure, the person may choose to become a Publisher and publish a course in step 123. In at least one embodiment of the present disclosure, the person may publish a course with another person and become a Copublisher in step 124. In at least one embodiment of the present disclosure, the person may collaborate with more than one publisher and create a set of courses designed to form an independent e-learning company or curriculum in the existing e-learning application in step 125.

In at least one embodiment of the present disclosure, the e-learning application may enable the person to advance to the next step of the method 120 after the person completes function-specific courses for the next step. In one example, the person may be able to progress from step 123 to step 124 only after the person successfully completes a course intending to train the person on how to be a successful Copublisher. In another example, the e-learning application may automatically enable publishing functionality to a person upon successful completion of at least one course that teaches the person how to become a Publisher.

Referring now to FIG. 1E, it is shown a method 130 of distributed online education according to at least one embodiment of the present disclosure. In at least one embodiment of the present disclosure, the method 130 includes a Student registering in step 131, the Student taking a course in step 132, the Student completing the course in step 133, the Student becoming a Coach for the course in step 134, the Student promoting the course in step 135, the Student taking more courses in step 136, the Student completing the additional courses in step 137, the Student becoming a Coach for the additional courses in step 138, and the Student promoting the additional courses in step 139. In at least one embodiment of the present disclosure, the method 130 enables a Student to successfully complete multiple courses and thereafter become a Coach for each completed course. It should be appreciated that the method 130 enables Students to take multiple courses over time, become Coaches for all completed courses, promote the completed courses, and earn income for providing the coaching service for the completed courses to others.

In at least one embodiment of the present disclosure, the Student registers in step 131. The Student may register, for example, in an e-learning application in step 131. During the registration process in step 131, the Student may be asked to input certain identifying information and/or payment information in order to purchase courses in the method 130. For example, the Student may be asked to provide billing information, shipping information for course materials, social media information, and other information necessary to facilitate taking of registered courses.

Referring now to FIG. 1F, it is shown a method 140 for distributed online education according to at least one embodiment of the present disclosure. As shown in FIG. 1F, the method 140 includes a Student purchasing a course in step 141, a confirmation of a session sent to a Coach in step 142, the Coach confirming a coaching session with the Student in step 143, the Student finishing the submission of all questions for the course in step 144, sending a last notice for confirmation of submittal of questions to the Coach in step 145, the Coach confirming a coaching session with the student in step 146, the Student requesting a new coach in step 147, and a Publisher of the course replacing the Coach in step 148. In at least one embodiment of the present disclosure, the method 140 includes a welcome notice being sent to the Student on behalf of the Coach in step 149 when the Student and Coach relationship is established.

In at least one embodiment of the present disclosure, the method 140 includes a Student purchasing a course. As described herein, a Student may purchase a course available on an e-learning application from a Publisher, Copublisher, Academy or other entity associated with the e-learning application. In at least one embodiment of the present disclosure, after the Student purchases the course, a Coach is identified and a session confirmation is sent to the Coach in step 142. In such an embodiment, the Coach and Student relationship is established in step 142, and the Coach is informed of the relationship. It should be appreciated that it is within the scope of the present disclosure that there may be multiple Coaches associated with a specific course and that a Coach for the Student may be selected through a variety of ways.

In at least one embodiment of the present disclosure, the Coach confirms the coaching session with the Student in step 143. In such an embodiment, the Coach may confirm the coaching session with the Student through interacting with an e-learning application. In the event that the Student and Coach relationship is established in step 142 and the Coach accepts the coaching session in step 143, then a notice is sent to the Student welcoming the Student to the course in step 149. In such an embodiment, the notice may include, but is not limited to, an email, private message within an e-learning application, social media message, text message, or other communication generated from an e-learning application.

However, in at least one embodiment of the present disclosure, if the Coach does not confirm the relationship between the Coach and Student, then the Student continues taking the course by responding to all of the questions associated with the course in step 144. In such an embodiment, the Student starts the process of answering questions associated with the course without having a Coach assigned to the Student. In at least one embodiment of the present disclosure, the Coach is notified an additional time to confirm the coaching session with the Student in step 145. In such an embodiment, the Coach may accept the coaching relationship with the Student or decline/ignore the request in step 146. In the event that the Coach does not confirm the coaching session with the Student, the Student may request a new Coach in step 147. In such an embodiment, the Publisher of the course becomes the Coach in step 148 or, alternatively, another Coach is selected from a list of available Coaches.

Referring now to FIG. 1G, it is shown a model for distributed online education according to least one embodiment of the present disclosure. As shown in FIG. 1G, the model displays a platform that may be implemented by a system for distributed online education on which many Student, Coaches, Publishers, Copublishers, and Independent Academies work together to create, promote and provide a wide variety of education solutions. As depicted in FIG. 1G and described herein, the systems and methods described herein promote collaboration and cross-marketing opportunities between Students, Coaches, Publishers, Copublishers, and Independent Academies which creates additional revenue opportunities for each party involved in the distributed online education systems and methods.

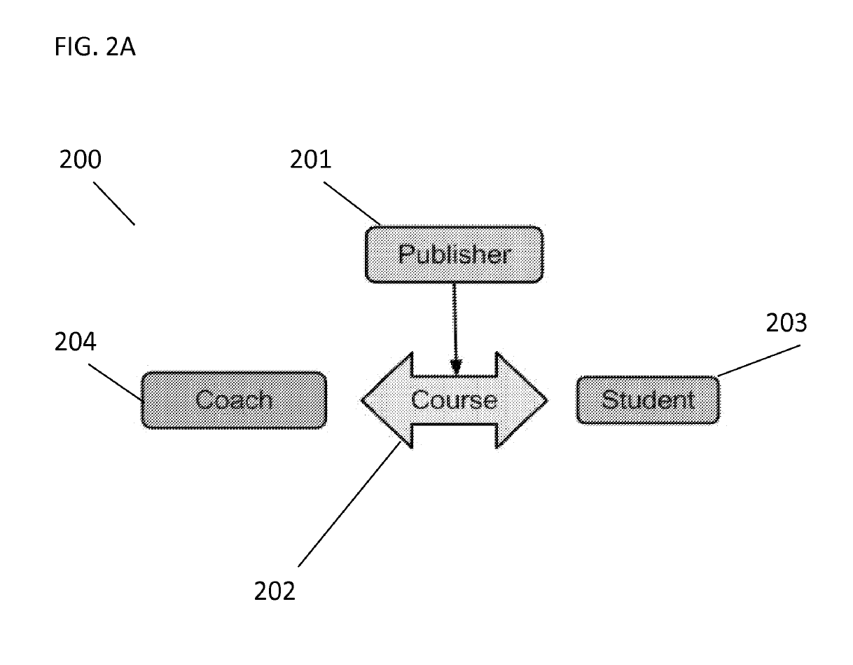

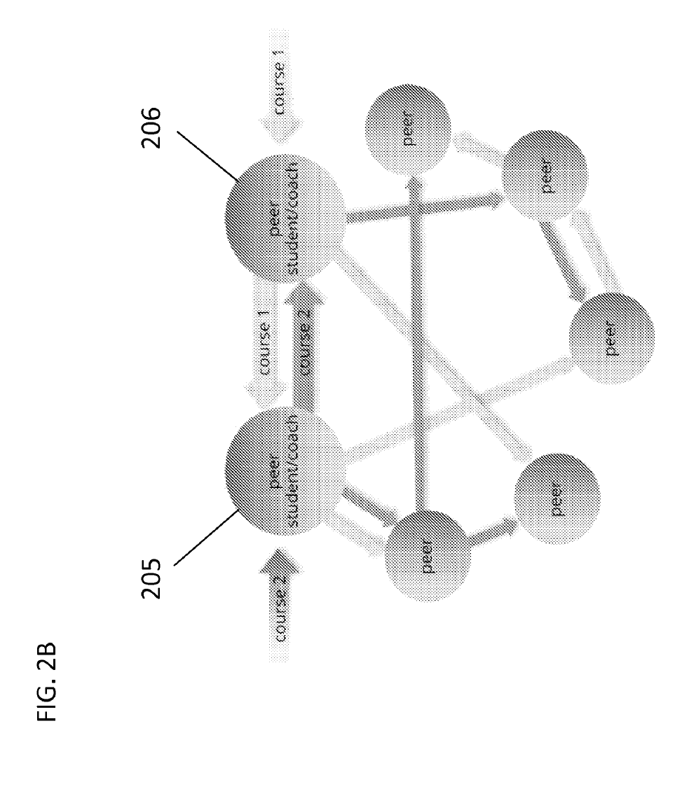

FIG. 2A shows a method 200 for distributed online education according to at least one embodiment of the present disclosure. As shown in FIG. 2A, a Publisher 201 creates a Course 202. In at least one embodiment of the present disclosure, a Student 203 completes the Course 202 created by the Publisher 201. In an exemplary embodiment, the Student 203 may promote the Course 202 by becoming a Coach 204 for the completed course. The Coach 204 promotes the Course 202 by teaching courses available on the Course 202 to a new Student 203. In an exemplary embodiment of the present disclosure, the number of Coaches 204 increases as more Students 203 are taught courses along the Course 202 and choose to become a Coach 204. In such an embodiment, the number of Students learning the course material increases exponentially as disclosed in FIG. 1A.

In at least one embodiment of the present disclosure, the Publisher 201 creates a Course 202 by uploading course materials to an e-learning website available on the Internet. In such an embodiment, the e-learning website provides a central repository for the storage of the course materials and/or interaction between a Publisher and Student. In such an embodiment, the Publisher 201 uploads a Course 202 which is available to one or more Students 203.

It should be appreciated that the e-learning website may store the course materials and associate such course materials with the Course 202 to enable Students 203 to sign up for the Course 202. It should be appreciated that the Course 202 may include a multitude of course materials. It should be appreciated that it is within the scope of this disclosure for the course materials to include, but not be limited to, a presentation, a document, an audio book, a webpage, a blog, a series of webpages, interactive media, a social media page, and/or a video.

It should be appreciated that it is within the scope of the present disclosure as shown in FIG. 2B for a teacher to be teaching a Student one Course while the teacher is also considered a Student on a second Course and is taught the associated course by that same Student who is a Coach on that Course, thereby reversing the roles. In other words, both Students happen to be coaching each other in a reciprocal relationship. For example, a teacher in step 205 acts as a Coach to a Student for a preparatory course for the SAT 10 in reading comprehension on a Course designed to prepare the Student to take the SAT 10 at a high school level. At the same time, the Student acts as a Coach in step 206 to the teacher for a course on how to balance a checkbook. In this example, the teacher is acting as a Coach to the Student for one course while the Student is acting as a Coach to the teacher in another Course. Therefore, we can see that the role a particular individual has within the system 300 and method 100 can change, and the role is assigned to that individual so such individual does not take on a Coach role for a given Course until he or she has successfully completing the coursework for that Course.

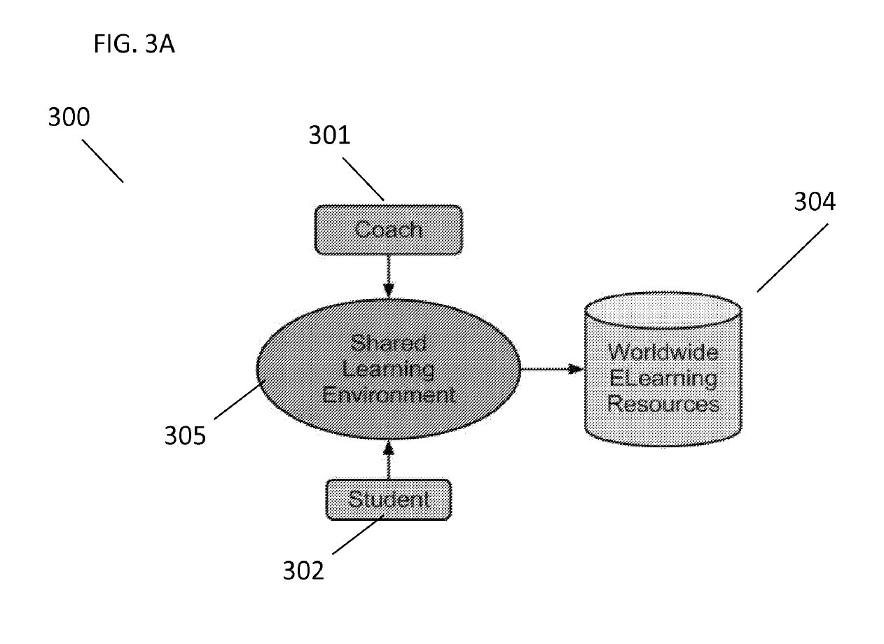

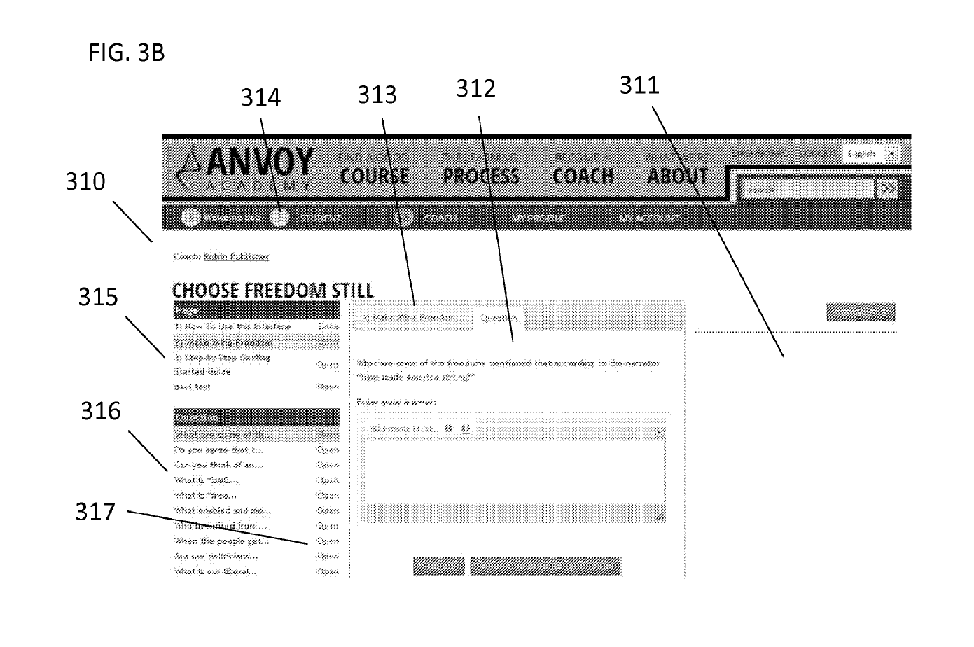

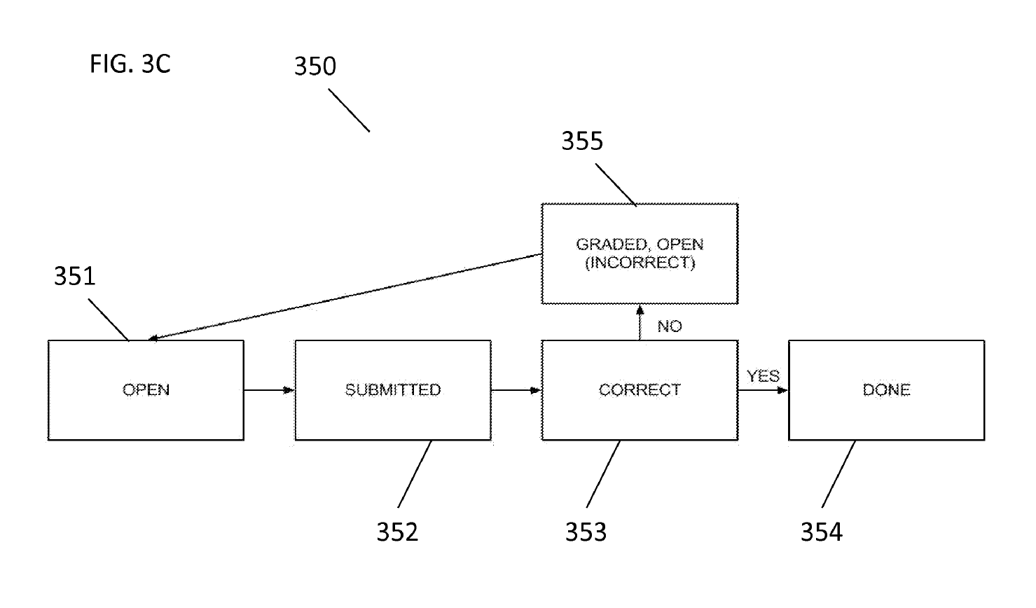

FIG. 3A discloses a system for distributed online education according to at least one embodiment of the present disclosure. As shown in FIG. 3, the system 300 includes a Coach 301, a Student 302, third party e-learning resources 304, and a shared learning environment 305. In at least one embodiment of the present disclosure, the Coach 301 and Student 302 collaborate through the third party e-learning resources 304 on the Internet. It should be appreciated that the Coach 301 and Student 302 may connect to the Internet and the third party e-learning resources 304 through any user device, such as, for example, a computer, mobile phone, smartphone, tablet, video communication device, or any user-interface device configured to access the Internet. It should be appreciated that the third party e-learning resources 304 may allow synchronous or asynchronous collaboration between the Coach 301 and Student 302 in real time, near real time, or on demand manner. Such e-learning resources may include, but are not limited to: a) communication resources, such as, for example, Skype, e-mail, AOL Instant Messenger, Google Talk, and Apple iChat; b) social media and networking, such as, for example, Reddit, Pinterest, Picasa, Facebook, LinkedIn, Twitter, and Google+; and c) web-based applications, such as, for example, Google Docs, Webpress, MediaWiki, Microsoft Sharepoint, Dropbox, and G-Drive. It should be appreciated that the types of actions able to be performed on the third party e-learning resources may include, but are not limited to, inserting pictures, posting text, posting video, communicating through text, communicating through video, highlight text, ask questions, reply to questions, communicate via audio, and other collaboration functions.

In at least one embodiment of the present disclosure, shared learning environment 305 is an e-learning application and/or website offered as a software as a service (SaaS) application available on the Internet configured to provide a customized format to the Coach 301 and the Student 302. In such an embodiment, the shared learning environment 305 customizes the interface to specifically tailor the content for the course in which the Coach 301 is teaching to the Student 302. In at least one embodiment of the present disclosure, the shared learning environment 305 pushes questions to be asked by the Coach 301 and answered by the Student 302 while also receiving at the shared learning environment 305 results of success or failure by the Student 302 in answering such questions. In such an embodiment, the shared learning environment 305 stores the results and is configured to provide a report card of a specific course for a Student 302 to a Coach 301 and Student 302 to determine whether the Student 302 has passed the course.

It should be appreciated that the shared learning environment 305 may push a variety of question types to the Coach and Student, including, but not limited to, multiple choice questions, essay questions, true/false questions, open-ended questions, mathematical questions, questions that have more than one answer, and other types of questions. In at least one embodiment of the present disclosure, the shared learning environment 305 may present a template of questions available to be selected through various web parts, such as, for example, raw text, questions asking for a radio button response, questions asking for a checklist response, questions asking for an audio response, and other types of questions asking for one or more responses from a variety of web parts available to the Publisher or the Coach 301. It should be appreciated that it is within the scope of the present disclosure that the Publisher or the Coach 301 may create a custom set of questions in the shared learning environment 305.

In at least one embodiment of the present disclosure, the system 300 is connected to third party e-learning resources 304. In such an embodiment, the third party e-learning resources 304 allow the Coach 301 and Student 302 to submit scores, content, grades, certification information, and other educational feedback and content to the third party e-learning resources. Third party e-learning resources may include, but are not limited to, online educational systems and reporting tools, such as, for example, Blackboard, Examsoft, and Adobe Connect. The connection between the shared learning environment 305 and the third party e-learning resources 304 enables the course content taught by the Coach 301 to integrate with any standing third party educational system.

FIG. 3B discloses a point in time representation of a graphical-user interface in a system for distributed online education according to at least one embodiment of the present disclosure. As shown in FIG. 3B, the graphical user interface 310 shows a communication pane 311 and an interactive document 312. In at least one embodiment of the present disclosure, the graphical user interface 310 is provided through the shared learning environment 305 disclosed in FIG. 3A. In such an embodiment, the communication pane 311 allows for communication directly between the Coach 301 and Student 302 through the shared learning environment 305.

The communication pane 311 allows for one on one, real time or near real time communication between the Coach 301 and the Student 302. It should be appreciated that the communication pane 311 shown in FIG. 3B is simply an example and any communication interface between the Coach 301 and Student 302 through the shared learning environment 305 is within the scope of this disclosure for the communication pane 311.

As shown in FIG. 3B, in at least one embodiment of the present disclosure, the shared learning environment 305 may include an interactive document 312. In such an embodiment, the interactive document 312 is displayed in the shared learning environment 305 which allows collaboration between the Coach 301 and the Student 302. In an exemplary embodiment, the Coach 301 and the Student 302 may add, delete, edit, and otherwise collaborate through the interactive document 312 in real time or near real time. For example, the real time or near real time collaboration between the Coach 301 and the Student 302 enables both the teacher and learner to learn from the process. In such an example, although the Coach 301 is further along the Course in which the Coach 301 and Student 302 are learning because the Coach 301 has already been coached on the material, both the Coach 301 and Student 302 are still able to learn from each other. In this example, the back and forth collaboration, communication, and interaction between the Coach 301 and the Student 302 enables a deeper understanding of the course material. In this example, the communication pane 311 and the interactive document 312 provides for such collaboration, communication, and interaction.

As shown in FIG. 3B, in at least one embodiment of the present disclosure, the course content is organized into Pages 315. Each Page is displayed on the content tab 313. Action Items 314 indicate tasks that the user must attend to. Questions related to each content Page are listed in area 316. The status 317 of each question is indicated for each question.

Referring now to FIG. 3C, it is shown a method 350 to grade a question in a course according to at least one embodiment of the present disclosure. The method includes the steps of setting the question status to open in step 351, a Student submitting an answer to the question in step 352, determining whether the submitted answer to the question is correct in step 353, if correct, marking the answer as correct in step 354, and, if not correct, marking the answer as incorrect in step 355. In at least one embodiment of the present disclosure, a question is initialized with the status of Open in step 351. The question may include, but is not limited to, a question presented to a Student while taking a course through an e-learning application. The person teaching the course, such as the Publisher or Coach, may present a question to a Student to answer to evaluate the Student's performance in the course. In such an embodiment, the question is initialized with a status of Open in step 351 to indicate that the Student has not yet responded to the presented question. In at least one embodiment of the present disclosure, the status of Open indicates that the question has yet to be answered by the Student taking the course and it is the Student's turn to interact with the question by providing an answer. In such an embodiment, the Student may submit an answer to the question to change the status of the question to Submitted and pass the question to the Coach in step 352. In at least one embodiment of the present disclosure, the course decides whether the answer to the question is correct or incorrect. In such an embodiment, if the Coach marks the question correct, then its status is set to Correct in step 354. Alternatively, in such an embodiment, if he marks the question as incorrect, the status is set to Graded or Open and the Student needs to improve the answer in step 355. In at least one embodiment of the present disclosure, the Student is given the opportunity to grade the Coach when the question is completed and the status of the question is set to Done in step 354.

In at least one embodiment of the present disclosure, grading multiple questions through the method 350 may create an overall grade for a course. By creating an overall grade for the course, an e-learning application may be able to determine a Student's overall performance in the course as compared to other students, such as, for example, through a percentile ranking between 1 and 99.

In at least one embodiment of the present disclosure, a percentile ranking may be calculated by participation in a single course, multiple courses, a Study Track, completion towards a certificate, and any other groups of grading activities described herein. In at least one embodiment of the present disclosure, an e-learning application may report a Student's performance, such as, for example, through assignment of percentile or relationship to an establish average grade of a Student. In such an embodiment, the e-learning application may enable the Student to post such report to the Student's social media through application programming interfaces within such social media. For example, an e-learning application may report to a Student through email that that the Student completed the “Algebra” course in the 99th percentile among all Students. In such report, the Student may select a “Post this to Facebook!” link that uses Facebook's application programming interface to create a Facebook Wall post that includes content around the Student's performance. For example, the content may include a link to the e-learning application with the text “Anvoy Track: Algebra, 99th”. It should be appreciated that the report may be communicated to the Student in a variety of ways, such as, for example, through posting in an e-learning application, via email, text message, and other communication methods.

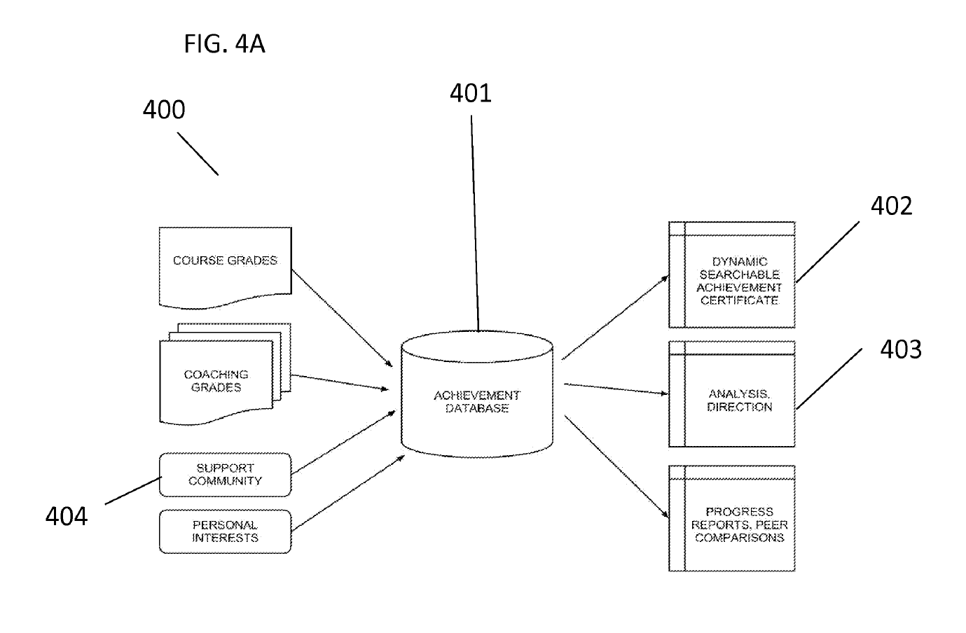

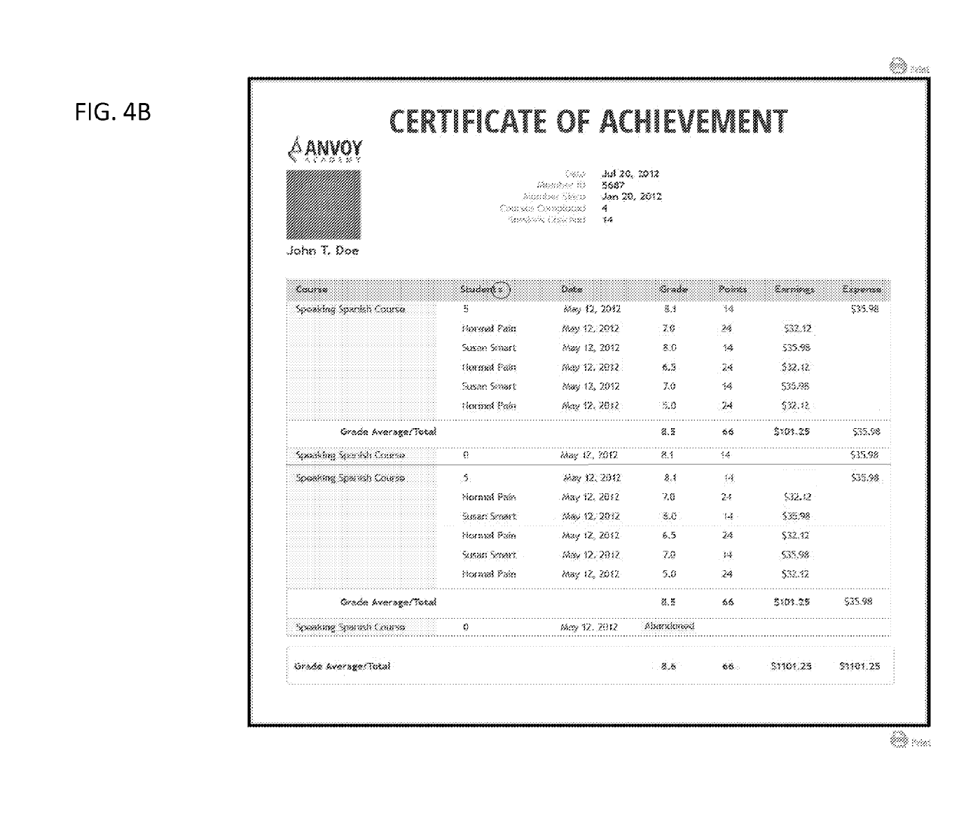

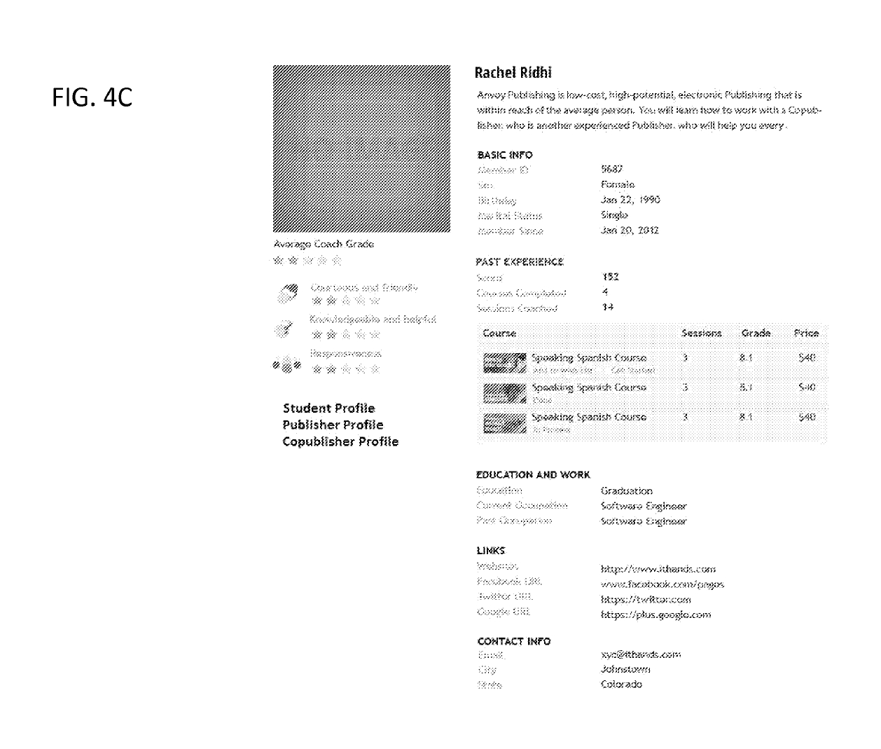

Referring now to FIG. 4, it is shown a system for distributed online education 400. In at least one embodiment of the present disclosure, the system for distributed online education 400 is presented as an e-learning application. In at least one embodiment of the present disclosure, the system includes an Achievement Database 401. In at least one embodiment of the present disclosure, the Achievement Database 401 holds a chronological, quantitative, and verified education and performance history of a Student's education in the e-learning application. In such an embodiment, the Achievement Database 401 may store, but is not limited to storing, the courses completed, the grade of each course completed, each Coaching engagement by the Student, and each Coaching grade given. In at least one embodiment of the present disclosure where the system 400 is presented as an e-learning application, the system 400 is configured to not only see the courses completed for each Student but also how each Student applied the knowledge as a Coach, with such information being stored in the Achievement Database. In at least one embodiment of the present disclosure, the Achievement Database 401 provides a detailed and chronological report of the Student's coursework, including, but not limited to, grades, types of courses completed, names of courses completed, and courses Coached. It should be appreciated that the report may include information about a single Course, multiple Courses, a single Course, multiple Courses, or any subset of information about a Student contained within the e-learning application.

In at least one embodiment of the present disclosure, the system 400 includes one or more education modules 404. In at least one embodiment of the present disclosure, the education modules 404 may include a Support Community. In a Support Community, Students, Coaches, and other registered users on the system 400 communicate together to solve problems, ask and answer questions, review Coaches, review courses, and generally collaborate about content available on the e-learning application 401. In such an embodiment, the education module 404 for a Support Community may be, but is not limited to, a forum, bulletin board, chat room, social network, mailing list, newsgroup, or other communication medium on the Internet.

In at least one embodiment of the present disclosure, the Support Community includes an algorithm and review process to quantify the learning process, Coaching process, and other educational milestones in order to guide Students on a Course. In such an embodiment, Students and Coaches of the e-learning application 401 provide feedback to the creators of courses, course materials, and directly to Coaches. In such an embodiment, the Students may provide feedback directly to Coaches as to the effectiveness of the specific Coach's teaching style, the helpfulness of the Coach in the learning process, the availability of the Coach, the answers that the Coach provided to the Student's questions, and/or the Coach's ability to fairly grade the Student. In such an embodiment, the Students and Coaches may provide feedback to the creator of the course (the Publisher) as to the general qualities of the course, such as, for example, the clarity of the course materials, the overall course experience, the knowledge gained by the Student from learning the course, the ability for the course to prepare the Student to become a Coach for the course, and other feedback. In at least one embodiment of the present disclosure, Students and Coaches may view the reviews and make decisions about which Course to pursue based on the feedback, comments, reviews, and discussions surrounding individual courses, Coaches, and course materials.

In at least one embodiment of the present disclosure, the system 400 may generate electronic achievement certificates 402 and analysis reports 403 that make course suggestions based on interests and aptitude, with such information being pulled from the Achievement Database 401. FIG. 4B shows an example of the electronic achievement report and FIG. 4C shows a Coach profile which also includes summary and detailed performance information.

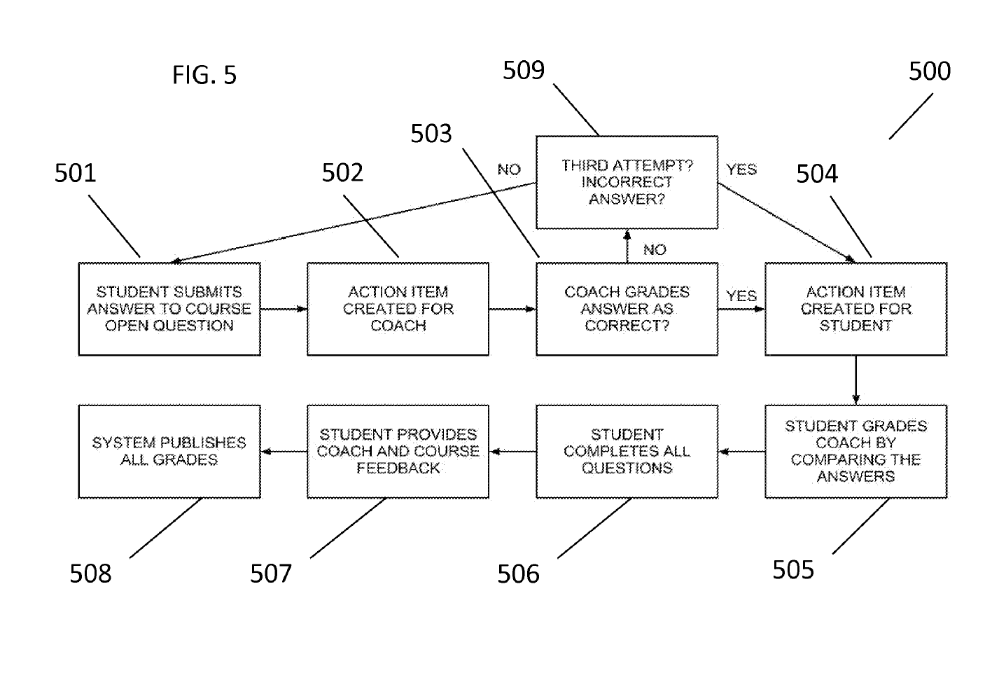

Referring now to FIG. 5, it is shown a method 500 for distributed online education according to at least one embodiment of the present disclosure. In at least one embodiment of the present disclosure, the method 500 includes a student submitting an answer to an Open course question in step 501, the answer being set as an action item to the question for a Coach in step 502, the Coach grading the answer as correct or incorrect in step 503, if the student provides an incorrect answer, evaluating whether to give the Student an additional chance to answer the question correctly in step 509, if the Student provides a correct answer, creating an action item for the Student related to the question in step 504, the Student grading the Coach in step 505, the Student completing all questions associated with a Course in step 506, the Student providing feedback on the Coach and the Course in step 507, and publishing grades in step 508. It should be appreciated that the method 500 may be implemented in an e-learning application or a module therein available on the Internet as disclosed herein.

In at least one embodiment of the present disclosure, the method 500 includes a Student submitting an answer to a Coach in step 501. In such an embodiment in step 502, the system creates an Action Item indicator that will prompt the Coach to grade the answer. In at least one embodiment of the present disclosure, the Coach compares the answer provided by the Student to the accepted answer in step 503. In such an embodiment, if the Coach grades the answer as incorrect, the question is sent back to the Student to allow the Student to provide an additional answer. In at least one embodiment of the present disclosure, steps 501, 502, 503, and 509 may loop to allow the Student to provide additional answers to a question until the Student correctly answers the question or the Student has hit the threshold for the number of attempts to correctly answer the question. In an exemplary embodiment, the Student may only provide three answers in an attempt to correctly answer the question. However, it should be appreciated that it is within the scope of the present disclosure for the steps 501, 502, 503, and 509 of the method 500 to loop any number of times to allow the Student to provide a correct answer to the question.

In at least one embodiment of the present disclosure, if the Coach marks the answer as correct, an action item is created for the Student in step 504. In such an embodiment, the action item identifies that the question has been answered correct and the Student should interact with the question in order to grade the Coach in step 505. In at least one embodiment of the present disclosure, the Student complete all the questions associated with a course in step 506 and may then provide feedback on the Coach and course materials in step 507. In at least one embodiment of the present disclosure, grades and feedback accumulated during the course is published in step 508.

In at least one embodiment of the present disclosure, the method 500 is invoked when a Coach is teaching a course to a Student. FIG. 5 discloses a method in which the Coach and Student are graded on the question, answer, and review process of an education system according to at least one embodiment of the present disclosure.

In at least one embodiment of the present disclosure, the Student submits an answer to the Coach in step 501. In such an embodiment, the Student may respond to a question submitted by the Coach through a shared learning environment in an e-learning application. The Student may submit an answer to the coach by filling out a form in the e-learning website, emailing the Coach, typing text into a communication pane, speaking through a video conference, posting to the Coach's social media, or other ways in which to submit online responses. It should be appreciated that the Student may be answering a variety of question types and, therefore, the Student's responses may be in a variety of forms, such as, for example, an objective multiple choice response, a paragraph response, a single word, or any length of response.

In at least one embodiment of the present disclosure, the Coach compares the answer submitted by the Student to the accepted answer in step 502. In such an embodiment, the accepted answer may include, but is not limited to, an answer created by the Coach, an answer already provided in the course materials by a Publisher, or an answer generally voted on by a community. In at least one embodiment of the present disclosure, the Coach, in the Coach's sole discretion, determines whether the Student's answer is correct. In at least one embodiment of the present disclosure, if the Coach determines that the Student's answer is incorrect, the Coach marks the answer incorrect and returns the answer to the Student. In such an embodiment, the Student attempts to respond to the question correctly again. In at least one embodiment of the present disclosure, the Student may attempt to correctly answer the question a limited number of times. For example, in the event that the Student incorrectly answers the question three times, the Coach may mark the question incorrect and the Student is not given the opportunity to answer the question again. It should be appreciated that in such an embodiment the number of times the Student has to attempt to correctly answer the question may be any number.

In at least one embodiment of the present disclosure, the Student's answer may be compared to the course materials directed to the question. In the event that the Student's answer is plagiarized from the course materials, the answer may be marked incorrect. In at least one embodiment of the present disclosure, an e-learning application automatically compares the Student's answer to the course materials through keyword, phrase or regular expression searching. In the event the e-learning application determines that the Student's answer is plagiarized, the e-learning application will mark the answer incorrect, inform the Coach of the plagiarism, or allow the Student to attempt to rewrite the answer.

In at least one embodiment of the present disclosure, in the event that the Coach accepts an answer as correct, the Student may view the correct answer in step 504. The correct answer may not be exactly the same as the answer provided by the Student in step 501. In at least one embodiment of the present disclosure, it is within the Coach's sole discretion as to whether to approve the answer as correct or incorrect. In such an embodiment, the Coach's subjectivity may determine the veracity of the answer. Nevertheless, it should be appreciated that it is within the scope of this disclosure that the answer may be an objective response, such as, for example, a multiple choice response or the answer to a math problem, and, therefore, the Coach's subjectivity is not at issue.

In at least one embodiment of the present disclosure, the answer may be automatically graded by the e-learning application. In such an embodiment, the answer is automatically scored by the e-learning application against the correct answer when the question is an objective question, such as, for example, a question asking for a true or false answer or a multiple choice question.

In at least one embodiment of the present disclosure, after the Student views the correct answer, the Student grades the Coach in step 505. In such an embodiment, the Student may grade the Coach on various aspects of the question and answer process, such as, for example, how well the Coach guided the Student to the answer, how well the Coach matched the provided answer by the Student to the accepted answer. It should be appreciated that the grading process by the Student and by the Coach improves the learning process by improving the Coach's teaching skills and providing direct feedback to the Student on whether the Student accurately answered the question.

In at least one embodiment of the present disclosure, the Student may grade the Coach on how well the Coach guided the Student to the correct answer in step 505. In such an embodiment, the Student evaluates the Coach's overall teaching methods and ability of the Coach to guide the Student through the course materials on a subjective basis. It should be appreciated that the Student's grade may be provided on a scale and/or through written feedback to the Coach. In at least one embodiment of the present disclosure, after the Student provides feedback to the Coach, the Student may view the overall grade that the Coach gave the member after completion of all of the questions in the Course in step 506. In such an embodiment, the Student is not allowed to view the grade given by the Coach until after the member grades the Coach to prevent the Student from providing a negative grade to the Coach in retaliation for a bad grade given by the Coach to the Student. In at least one embodiment of the present disclosure, the grades will not be revealed to either the Student or the Coach until both the Student and Coach submit grades.

In at least one embodiment of the present disclosure, the Coach and Student may provide feedback on the question and the course material in step 507. In such an embodiment, the Coach and Student provide feedback that may be used by future Coaches and Mentors or are included as modifications to the course by the Publisher. It should be appreciated that this step is optional and the Coach and Student are not required to submit any feedback to any specific question or about the course.

In a preferred embodiment, the manual grading process provides human validation of a Student's knowledge of the course material and a Coach's ability to teach the course material to the Student. In such an embodiment, the combination of the human validation and the structured approach to grading in method 500 enables the Student and Coach to be more creative in teaching, learning, and grading the course material.

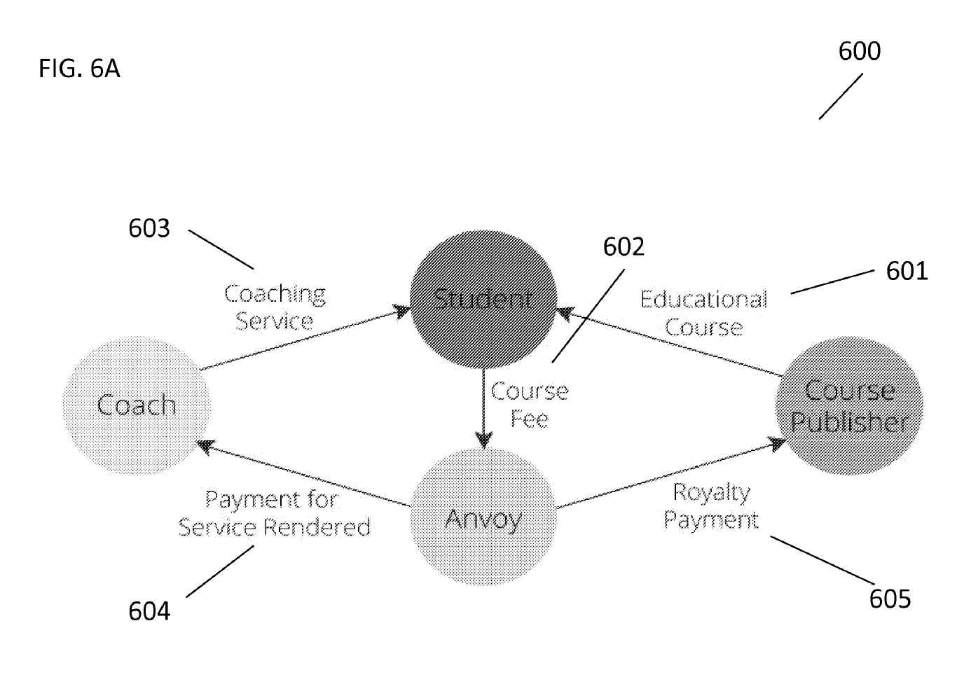

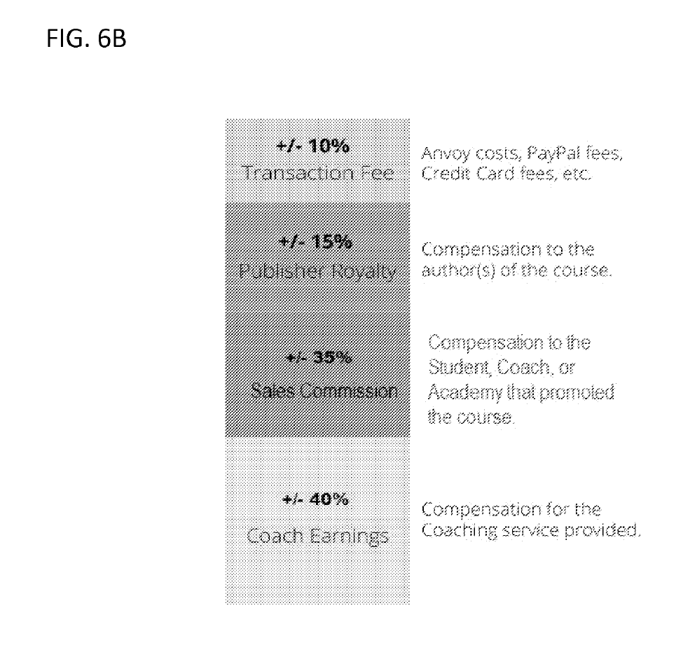

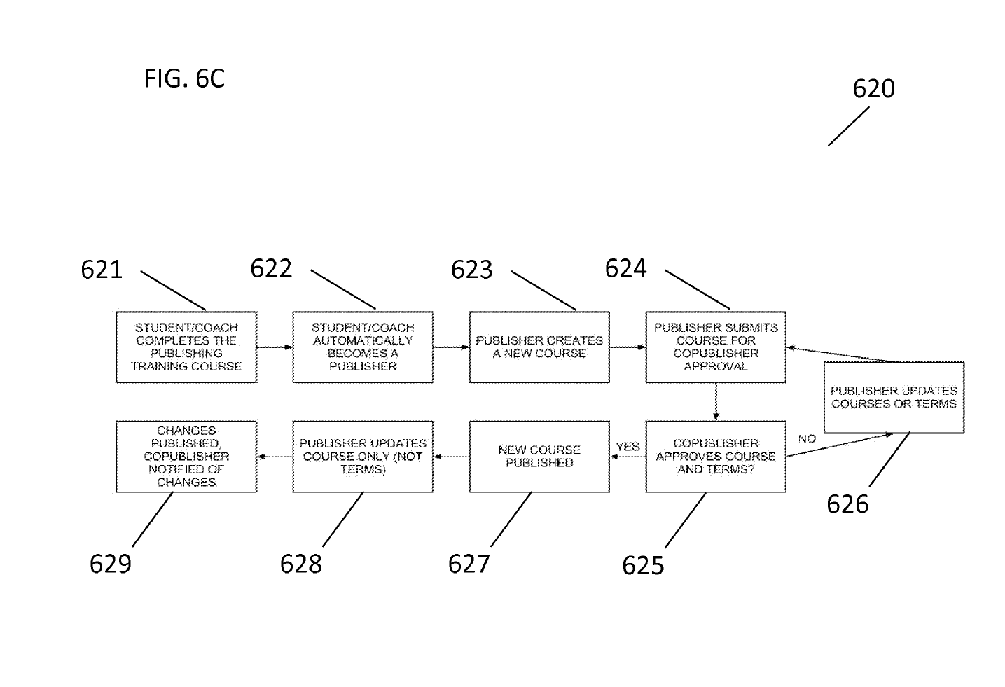

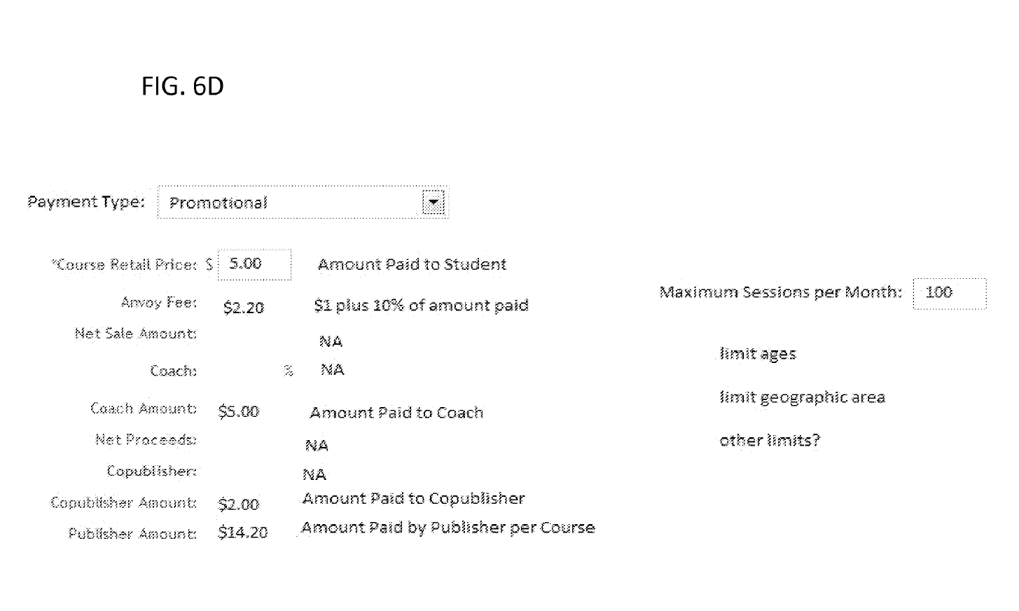

Referring now to FIG. 6, a method for distributed online education is disclosed according to at least one embodiment of the present disclosure. As shown in FIG. 6, the method 600 includes a Publisher publishing a course at step 601, a Student purchasing the course at step 602, a different Student becoming a Coach and providing a coaching service at step 603, the Student getting paid for providing the service at step 604, and the Publisher earning a royalty in step 605.

In at least one embodiment of the present disclosure, a Publisher publishes and provides a course at step 601. In such an embodiment, the Publisher publishes a set of course materials with the course. The course materials may include a single course or a set of courses. The course materials may include, but are not limited to, a syllabus, on-demand videos, questions and answers, a course book, an e-book, a presentation, reference materials, and other materials to enable learning by Students purchasing the course. In at least one embodiment of the present disclosure, the Publisher publishes the course on an e-learning application available on the Internet as a SaaS application. It should be appreciated that the e-learning application may facilitate Students purchasing the course, providing the course to Students, storing grades obtained in the course, and all aspects of the administrating the course.

In at least one embodiment of the present disclosure, a Student purchases the course at step 602. In such an embodiment, the Student pays the Publisher a fee for the cost of the course. In such an embodiment, the Publisher provides the course materials to the Student for learning. The Student learns the course from the Publisher and/or learning materials and obtains a grade after completion of the course. It should be appreciated that the Publisher may or may not have a direct role in administering the course with the Student. However, the Publisher is incentivized to instruct the Student well in order to prepare the Student to teach the course to future Students as a Coach.

In at least one embodiment of the present disclosure, the Student becomes a Coach for the course. In at least one embodiment of the present disclosure, the Student obtains a passing grade from the Publisher for the course and chooses to teach the course to future Students. Upon becoming a Coach, the Student is available to teach Students the course through the course materials provided by the Publisher. It should be appreciated that it is within the scope of this disclosure that the Coach may teach the course to Students without the involvement of the Publisher or with involvement from the Publisher. In an exemplary embodiment, the Coach teaches the course to Students without the Publisher's assistance. In at least one embodiment of the present disclosure, the Publisher may teach the course with the Coach to Students until the Coach is comfortable enough to teach the course without the Publisher.

In at least one embodiment of the present disclosure, a Student purchases the course from the Coach in step 602. In an exemplary embodiment, the Student purchases the course and pays the Coach a fee as defined by the Publisher. It should be appreciated that the Student may pay the fee through a variety of ways, such as, for example, through payment in an e-learning application. In at least one embodiment of the present disclosure, the Student purchases the course and pays the Coach a fee negotiated between the Coach and the Student or set by the Coach. It should be appreciated that it is within the scope of this disclosure that any course fee structure may be established between the Student and Coach for the course.

In at least one embodiment of the present disclosure, the Coach pays a royalty fee to the Publisher to teach the course. In an exemplary embodiment, the Coach and Publisher negotiate a royalty fee that the Coach will pay the Publisher for any Students in which the Coach teaches the course. It should be appreciated that there may exist multiple Coaches available to teach the course to multiple Students and that it is within the scope of this disclosure that there may be different royalty rates paid by each Coach. In at least one embodiment of the present disclosure, the varying royalty rates may be due to the Coach's experience, grade obtained by the Coach in the course, how many Students the Coach has already taught, and other factors.

In at least one embodiment of the present disclosure, an e-learning application hosting the course and/or facilitating the teaching of the course to the Coach and/or Student takes a royalty of payments made to the Publisher or Coach in the method 600. In such an embodiment, the e-learning application may provide such hosting and facilitation through a shared learning environment, online portal, or other collaboration tools.

In at least one embodiment of the present disclosure, a Student may receive an acceptable grade in the course and decide to become a Coach. In such an embodiment, the steps 603, 604, and 605 in the method 600 are repeated with the Student as the Coach. In such an embodiment, the Student teaching the course receives payment from the Students in which the Student teaches the course and the Publisher receives a royalty of such payments. It should be appreciated that such an embodiment incentivizes the Students to learn the course well in order to be able to profit from teaching the course to other Students. It should be appreciated that such an embodiment further incentivizes the Publisher to provide a high-quality course in order to profit from the course being taught by Coaches to new Students within the system.

It should be appreciated that it is within the scope of the present disclosure for the Publisher, Student, and Coach to arrange any payment structure that incentivizes the Student to become a Coach and the Coach to participate in reselling the Publisher's courses. Such incentive arrangements may include, but are not limited to, a flat fee per course taught by the Coach, a flat fee for the Student choosing to become a Coach, an incentivized fee where the Coach is paid a percentage of the cost of the course and such percentage increases as the Coach gains experience, a percentage of the cost of the course based on how many Students the Coach is teaching at any given time, and any other payment arrangement between the Coach, Student, and/or Publisher. FIG. 6B, for example, shows an example of how the course fee paid by the Student may be distributed to the Publisher and Coach for a normal course. It should be appreciated that it is within the scope of the present disclosure to distribute the course fee paid by the Student to the Publisher and Coach in any configuration and that the disclosure in FIG. 6B is merely an example.

In at least one embodiment of the present disclosure, the payment by a Student for a Course may be divided between multiple parties involved in promoting, teaching, and supporting the Course. In at least one embodiment of the present disclosure, a portion of the fee paid may be distributed as a commission to the party promoting the Course. For example, as shown in FIG. 6B, a sales commission may be distributed as compensation to a Student, Coach, or Academy that promotes the Course.

In at least one embodiment of the present disclosure, the commission is given to the party based on promotion. For example, in the event that the sale of the Course results from a special advertisements, promotion, or web address (URL) provided by a specific Coach, the Coach will be distributed the commission. In another example, if the sale occurs from a purchase made on an Academy website, the Academy will receive the commission. In another example, a Student may promote a course in an advertisement, promotion, web address, or otherwise, and any sales resulting from the Student's promotional activities may bestow the commission to the Student. In another example, if the sale of the Course occurs simply through an e-learning application without any promotion from any other party, the e-learning application may keep the commission. It should be appreciated that the distribution of a sales commission incentivizes the Student, Coach, and Academy to promote the Course to more Students, which, in turn, will advance learning.

In at least one embodiment of the present disclosure, the distribution of the payment from a Student for a Course is configurable in an e-learning application. For example, as shown in FIG. 6D, the distribution of a specific course may be distributed between a Coach, Copublisher, and Publisher.

Referring now to FIG. 6C, it is shown a method 620 of online distributed education according to at least one embodiment of the present disclosure. In at least one embodiment of the present disclosure, the method 620 includes a Student or Coach completing a publishing training course in step 621, a Student or Coach becoming a Publisher in step 622, a Publisher creating a new course in step 623, the Publishing submitting the course for approval from a Copublisher in step 624, the Copublisher choosing to approve or not approve the course in step 626, the Publisher updating the course terms in the event that the Copublisher does not approve the course in step 626, publishing the course in step 627, the Publisher updating the contents of the course in step 628, and publishing the changes to any course and notifying the Copublisher in step 629.

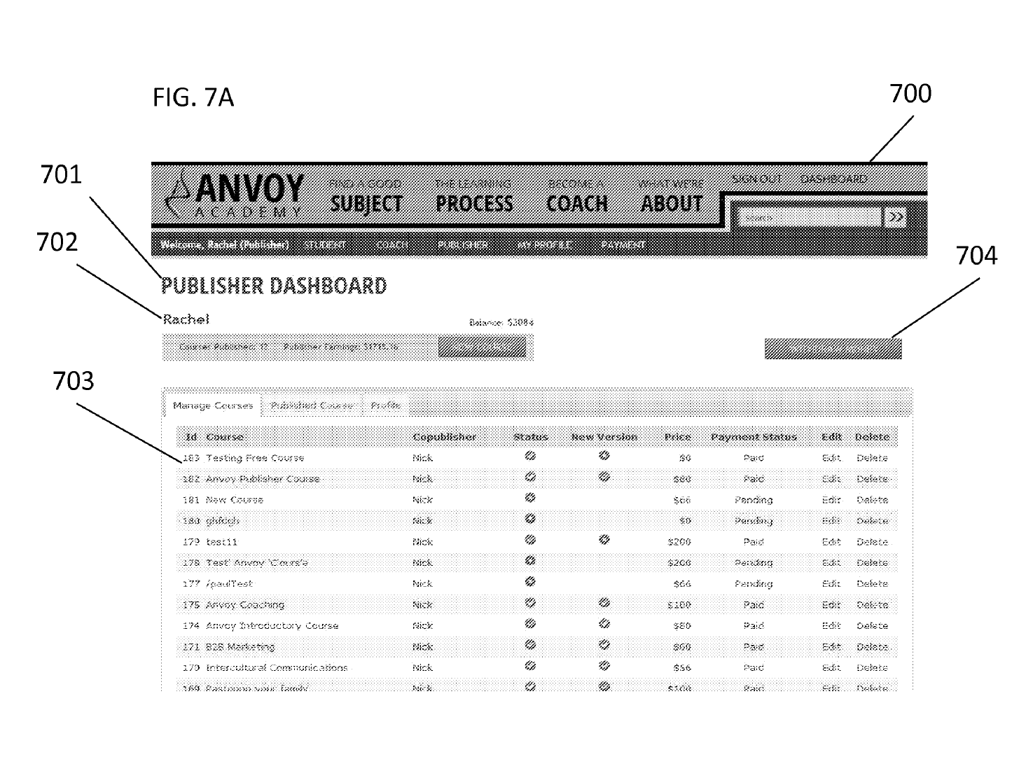

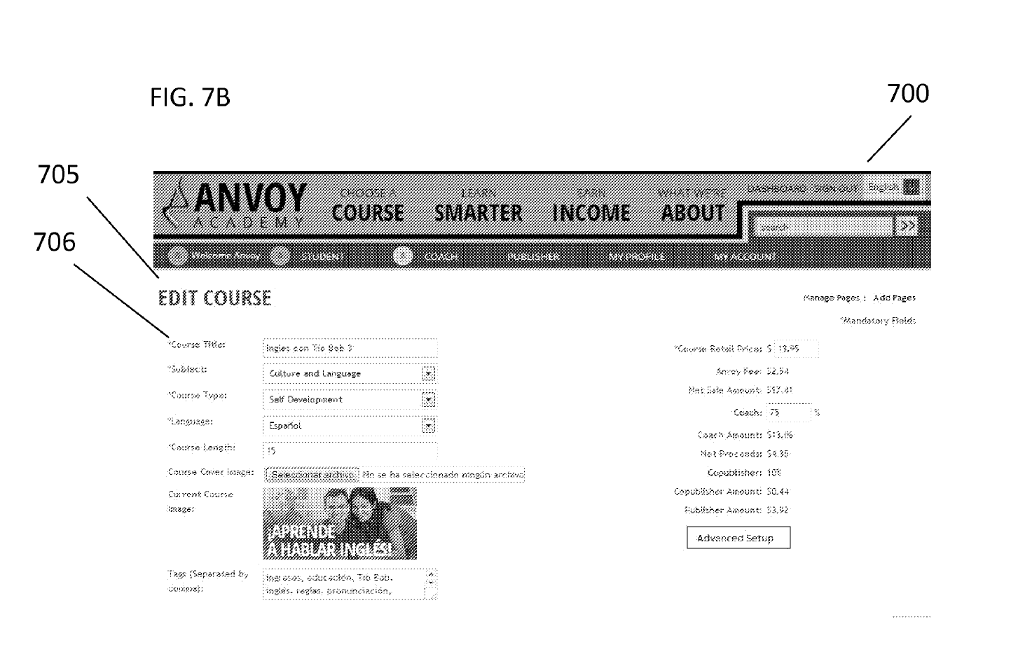

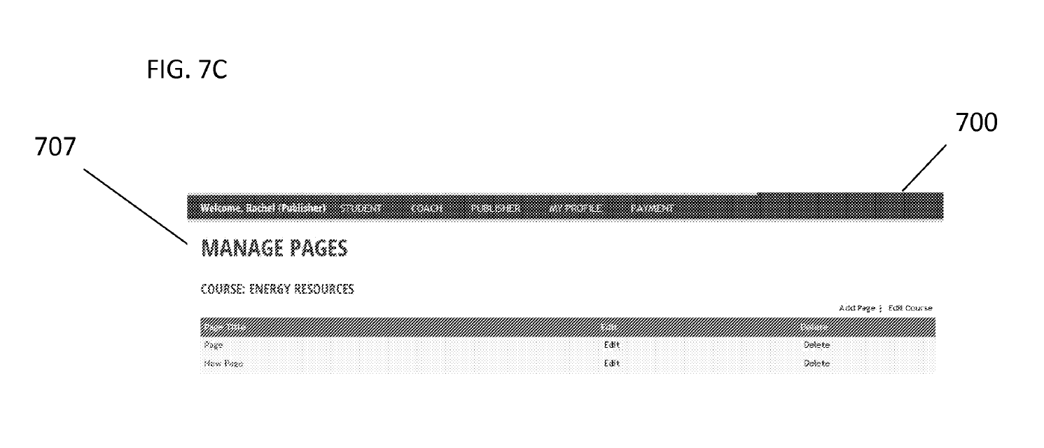

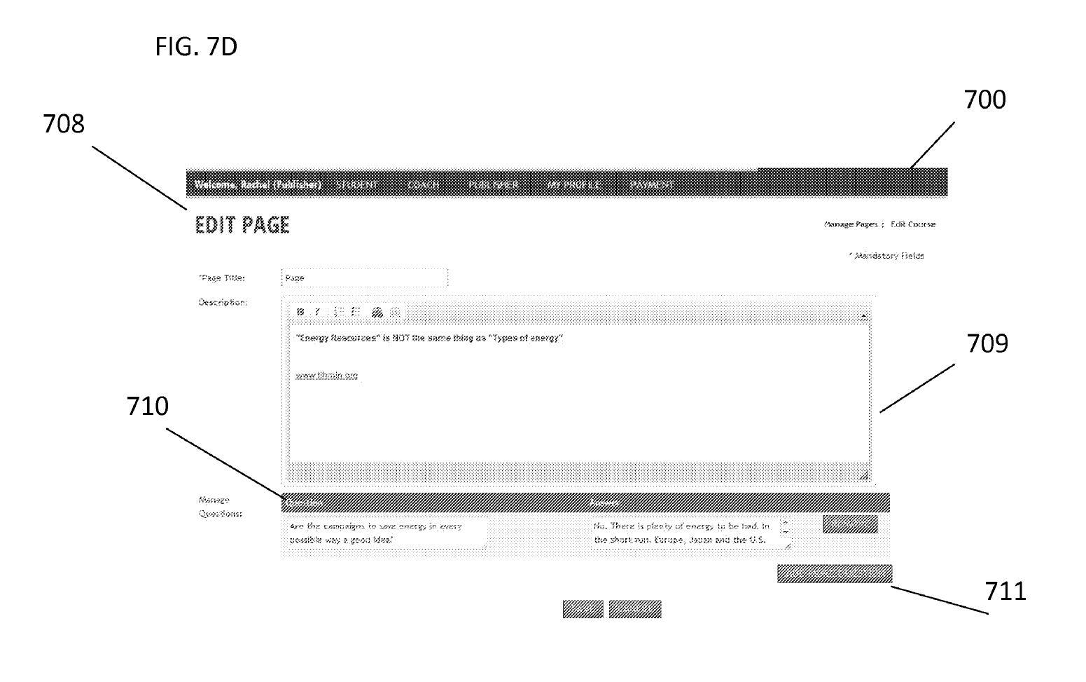

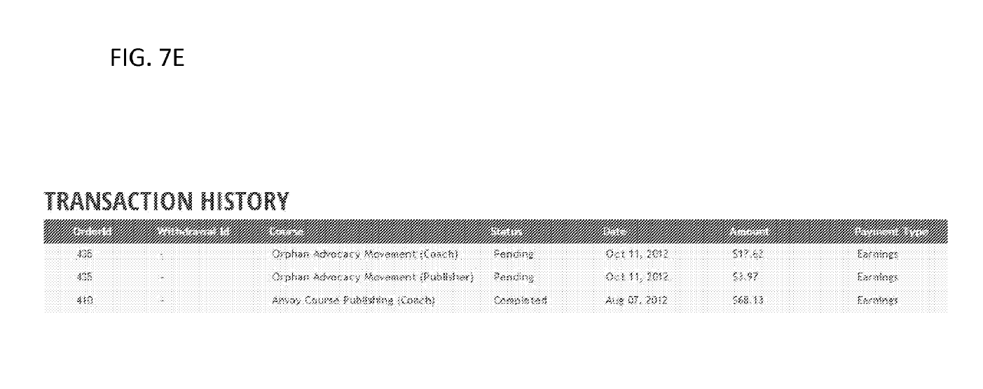

Referring now to FIG. 7A, a system for distributed online education according to at least one embodiment of the present disclosure is shown. In at least one embodiment of the present disclosure, the system 700 includes a Publisher Dashboard 701, an information pane 702, a list of courses published 703, and the ability to withdraw money 704. FIG. 7E shows the transaction history whereby the system tracks earnings and withdrawals.

In an exemplary embodiment, the system 700 is implemented through a SaaS model available on the Internet as an e-learning application. In such an embodiment, interested Publishers and Students may interact with the e-learning application to eventually publish courses in the Publisher Dashboard 701.

In at least one embodiment of the present disclosure, the system 700 includes a Publisher Dashboard 701. In at least one embodiment of the present disclosure, the Publisher Dashboard 701 includes a general overview of courses published by a Publisher. In such an embodiment, the Publisher Dashboard 701 includes information about the Publisher, such as, for example, the Publisher's user name, the number of courses published by the Publisher, how much the Publisher has earned from publishing courses through the e-learning application, and other information. It should be appreciated that the information available to the Publisher in the Publisher Dashboard 701 includes a point-in-time representation of the Publisher's performance in the e-learning application. In such an embodiment, the Publisher Dashboard 701 enables the Publisher to determine which courses are most profitable to the Publisher, to adjust prices of individual courses, to edit courses, and to make other changes to the Publisher's profile in an attempt to profit from the use of the e-learning application.

In at least one embodiment of the present disclosure, the system 700 includes an information pane 702. In such an embodiment, the information pane 702 provides information the Publisher about the status of the Publisher's published courses, such as, for example, the number of courses published, the publisher's earnings, and other information. In at least one embodiment of the present disclosure, the information pane 702 also enables the Publisher to publish a new course in the e-learning application to become available to be purchased by Students and to recruit Students who complete the course to become Coaches.

It should be appreciated that it is within the scope of the present disclosure for more than one Publisher to work together and publish one or more courses together. In such an embodiment, the Publishers may share a Publisher Dashboard 701 in the system 700 through a joint account. In an exemplary embodiment, the Publishers have individualized accounts with individual Publisher Dashboards 701 that display the joint courses and the Copublisher. In one example, as displayed in FIG. 7, the Publisher Rachel 702 has copublished courses with Nick as shown in the course listing 703. In such an example, Rachel and Nick have created numerous courses together of varying topics and of various price offerings.

In at least one embodiment of the present disclosure, the Publisher may not be authorized to publish courses or view a Publisher Dashboard 701 until the Publisher completes a specialized training for Publishers which may include, for example, how to use the e-learning application, how to create a quality course, and/or how to arrange a fee structure with prospective Coaches.

In at least one embodiment of the present disclosure, the system 700 includes a withdraw money function 704 for the Publisher. In such an embodiment, the Publisher may withdraw money by clicking a button 704. In at least one embodiment of the present disclosure, the available funds to be withdrawn by the Publisher include the amount listed in the Publisher's Publisher Dashboard 702. In one example, as shown in FIG. 7, the Publisher is able to withdraw $3084 through the withdraw money functionality 704. It should be appreciated that the withdraw money functionality 704 may provide funds to the Publisher through a variety of methods, including, but not limited, to issuing a direct deposit to a Publisher's bank account, issuing a check paid to the Publisher, and depositing funds in the Publisher's online payment system, such as, for example, PayPal.

In at least one embodiment of the present disclosure, the Publisher may choose to edit one or more courses displayed on the Publisher Dashboard 701. Upon choosing the edit functionality on the Publisher Dashboard 701, the e-learning application presents the Publisher with an edit page.

Referring now to FIG. 7B, an edit page of the system 700 according to at least one embodiment of the present disclosure is displayed. In such an embodiment, the Edit Course 705 page enables the Publisher to modify details about one or more courses available on the e-learning application through the system 700. In at least one embodiment of the present disclosure, the Publisher is presented with a list of editable content for the course 706. In such an embodiment, the Publisher may alter the course title, subject, course type, course length (in pages, hours, or length of content), a cover image for the course, associated search engine optimization tags with the course, a short description of the course, the price of the course, and the portion of the fee paid to a Coach in the event the Coach teaches a Student. It should be appreciated that the editable content disclosed in FIG. 7B is only an example of editable content in the Edit Course 705 page for the system 700. It should be appreciated that it is within the scope of the present disclosure to enable the Publisher to perform other edits to the course in the Edit Course 705 page, including, but not limited to, uploading new course materials, adding additional pictures to the course, defining Coaches for the course, and other elements to enable learning in the e-learning application. In at least one embodiment of the present disclosure, the Edit Course 705 page displays the fees paid to the Coach, e-learning application, and Copublisher in each sale of the course.

In at least one embodiment of the present disclosure, the Publisher may choose to edit the course content in the Edit Course 705 page. In such an embodiment, the Publisher is presented with a webpage that allows the Publisher to edit course materials and course content directly. Referring now to FIG. 7C, it is shown a Manage Pages 707 webpage according to at least one embodiment of the present disclosure. In such an embodiment, the system 700 presents the Publisher with a course-specific webpage to enable the Publisher to add, remove, and edit course content directly in the e-learning application.

Upon choosing to edit course materials, the system 700 may present the Publisher with a graphical user interface for the Publisher to input altered course content. Referring now to FIG. 7D, the system 700 presents the Publisher with an Edit Page 708 page in at least one embodiment of the present disclosure upon the Publisher selecting to edit course content. In an exemplary embodiment, the Publisher inputs text into a text box 709 according to the course content that the Publisher intends to provide. The text box 709 may allow the Publisher to input raw text, HTML, vBulletin code, or any other type of markup language or coding language to enable the Publisher to create rich course content for display on the e-learning application. In an exemplary embodiment, the text box 709 provides word processing capabilities to the Publisher, such as, for example, the ability to insert hyperlinks, create bulleted lists, bold text, italicize text, and upload photos.

In at least one embodiment of the present disclosure, the Publisher may input questions and acceptable answers in the question and answer dialogue box 710. It should be appreciated that the question and answer dialogue box 710 may allow the Publisher to input any type of question and ask for any type of response, such as, for example, a multiple choice question, an essay question, a question with only one answer, and a question with multiple answers. In at least one embodiment of the present disclosure, the Publisher may add more than one question 711. It should be appreciated that the Edit Page 708 webpage may enable the Publisher to input any content to the course materials within the scope of this disclosure and the Edit Page 708 shown on FIG. 7D is merely an example of at least one embodiment of the present disclosure.

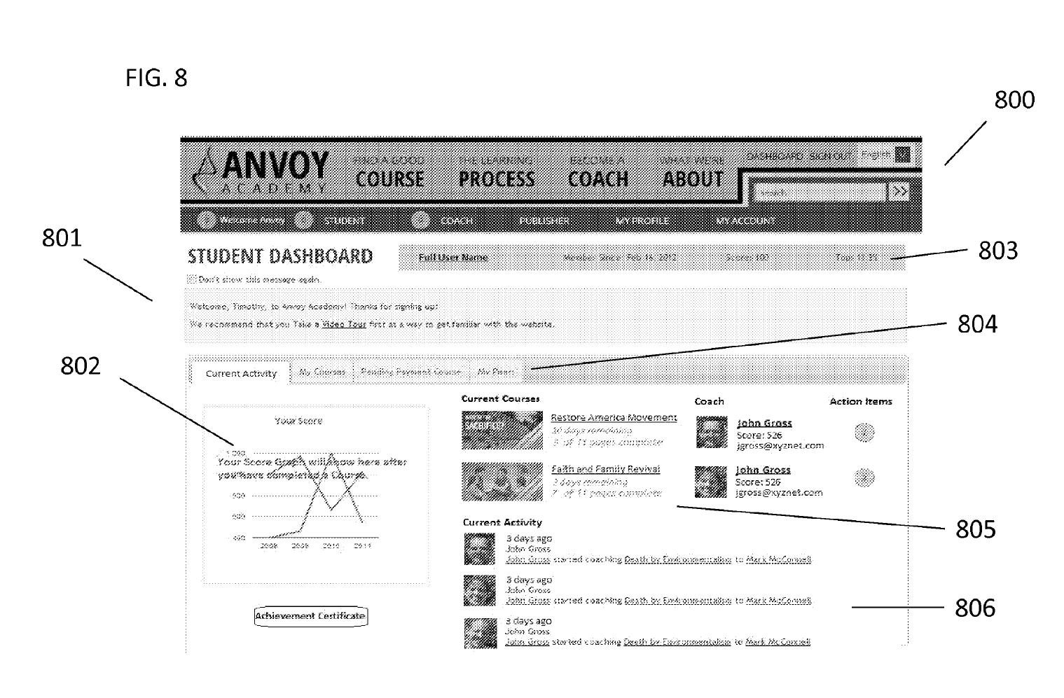

Referring now to FIG. 8, an exemplary embodiment of a system for distributed online education 800 is shown. In an exemplary embodiment, the system 800 is provided to a Student in the form of an e-learning application available on the Internet. In at least one embodiment of the present disclosure, the system 800 includes a Student's Dashboard 801, a graphical performance information pane 802, and an overall performance pane 803. Functions are included to add Learning Peers 804. The Student dashboard shows a list of the courses in process for the Student 805 and also the learning activity for Peers 806. In at least one embodiment of the present disclosure, a Student using an e-learning system is presented with the system 800 to perform learning activities and to check on the overall performance of the Student in the e-learning application.

In at least one embodiment of the present disclosure, the Student Dashboard 801 displays the listing of courses taken by the Student with information important to the Student about each course in a course information pane 802, such as, for example, the name of the course, the Coach or Publisher teaching the course to the Student, the price paid by the Student for the course, the state of the course, and actions able to be performed in each course. It should be appreciated that the course information pane 802 may enable the Student to interact directly with the course to delete the course from the Student's course listing, answer questions about the course directly, and to provide feedback on the course and/or the Coach teaching the course.

In at least one embodiment of the present disclosure, the Student Dashboard 801 includes an overall performance pane 803. The overall performance pane may include information about the Student's overall performance in the e-learning application, such as, for example, the number of courses completed, the Student's score in the selected course, an overall score in all courses, the ranking of the Student compared to other Students and other information pertinent to the Student's learning in the e-learning application.

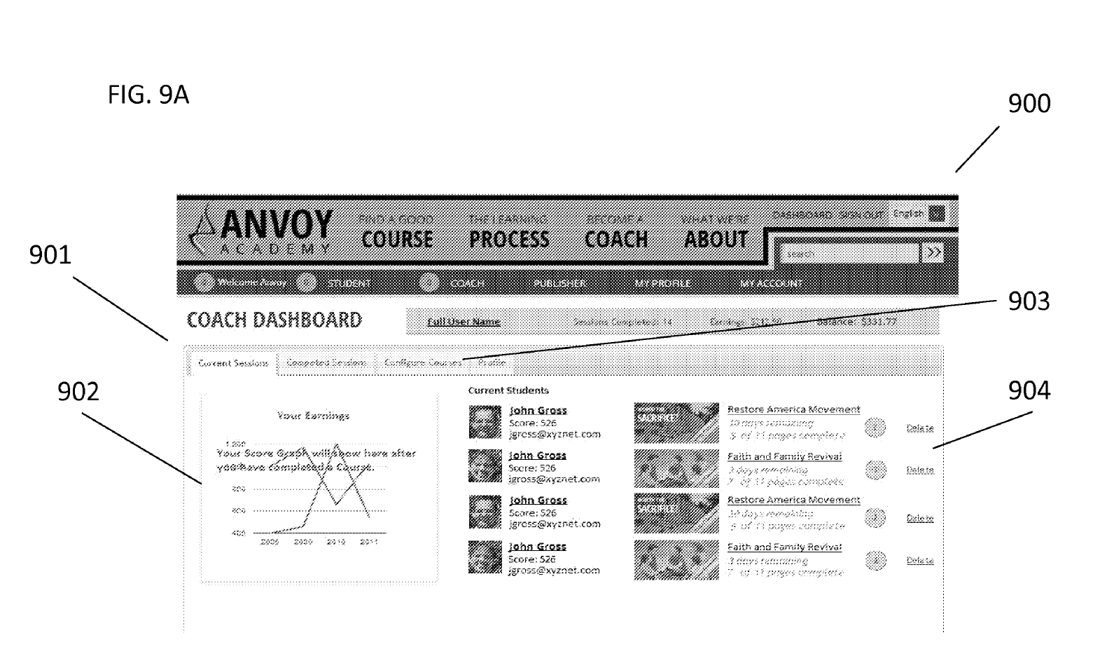

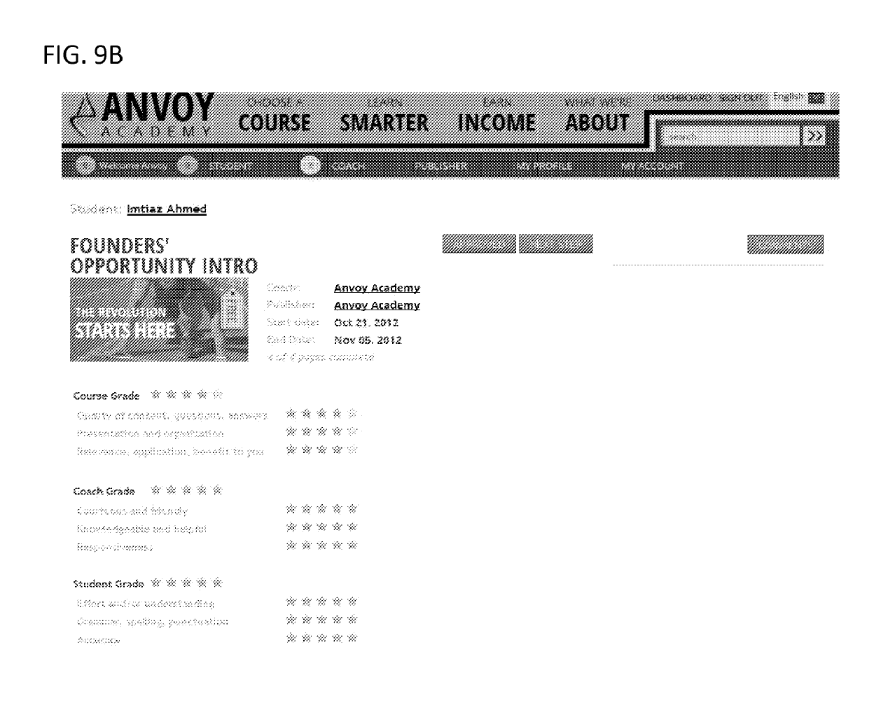

Referring now to FIG. 9A, a system for distributed online education 900 is shown according to at least one embodiment of the present disclosure. In an exemplary embodiment, the system 900 is available in the form of an e-learning application available on the Internet. In at least one embodiment of the present disclosure, the system 900 includes a Coach Dashboard 901 and a Coach information pane 902. Functions are included to configure the courses that the Coach is promoting 903, such as deactivating courses that she no longer wants to coach, or setting criteria which limit the type of Student they will accept. A list of the Students that are currently being coached is shown 904.

In at least one embodiment of the present disclosure, the Coach may interact directly with each Student in each Course in the Course Dashboard 901. In one example as disclosed in FIG. 9A, the Coach may click on the “Faith and Family Renewal” course where the Coach is teaching John Gross and interact directly with John's progress in the course. In this example, the Coach may review John's progress, submit questions to John, review John's answers to questions, grade John, and perform other teaching functions to assist John in learning the course.

It should be appreciated that the Coach Dashboard 901 disclosed in FIG. 9A is only one example according to the present disclosure and any information about the Coach's progress in teaching Students in the e-learning application may be available to the Coach in the Coach Dashboard 901. It should be appreciated that it is within the scope of the present disclosure for the Coach to edit fields, information, and the display of the Coach Dashboard 901 specifically for the Coach's preferred use.

In at least one embodiment of the present disclosure, the Coach may withdraw money in the Coach Dashboard 901. It should be appreciated that it is within the scope of the present disclosure for a Coach to also be a Publisher. As shown, for example, in FIG. 9A, the balance according to the Coach Dashboard 901 is $331.77 whereas the Coach's earnings are only displayed as $212.90. In this example, the discrepancy between the available balance for the Coach and the amount the Coach earned while teaching Students shows that the Coach has also earned fees from acting as a Publisher. In at least one embodiment of the present disclosure, the payment process in the e-learning application is automated or uses a third-party payment processor, such as, for example PayPal.

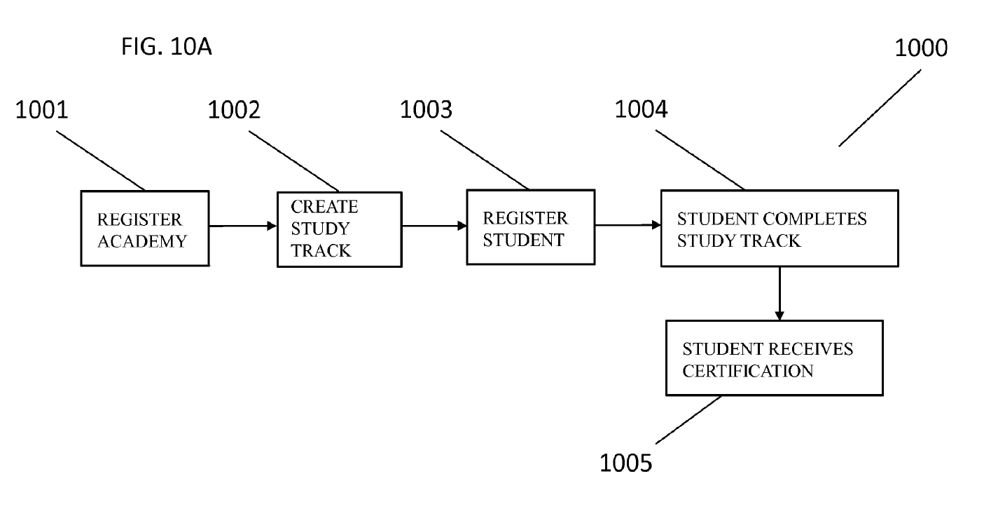

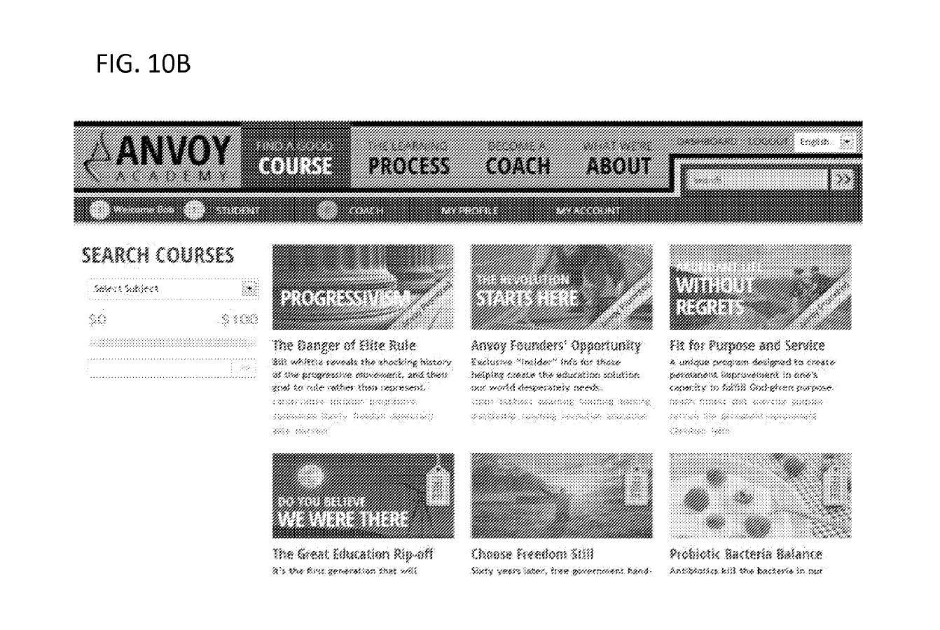

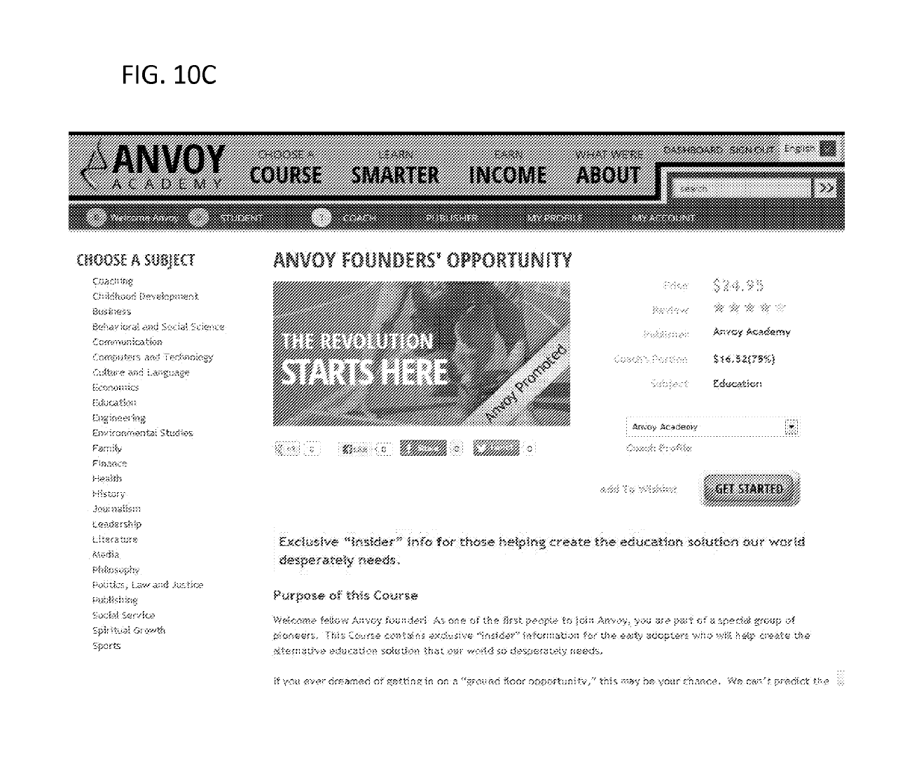

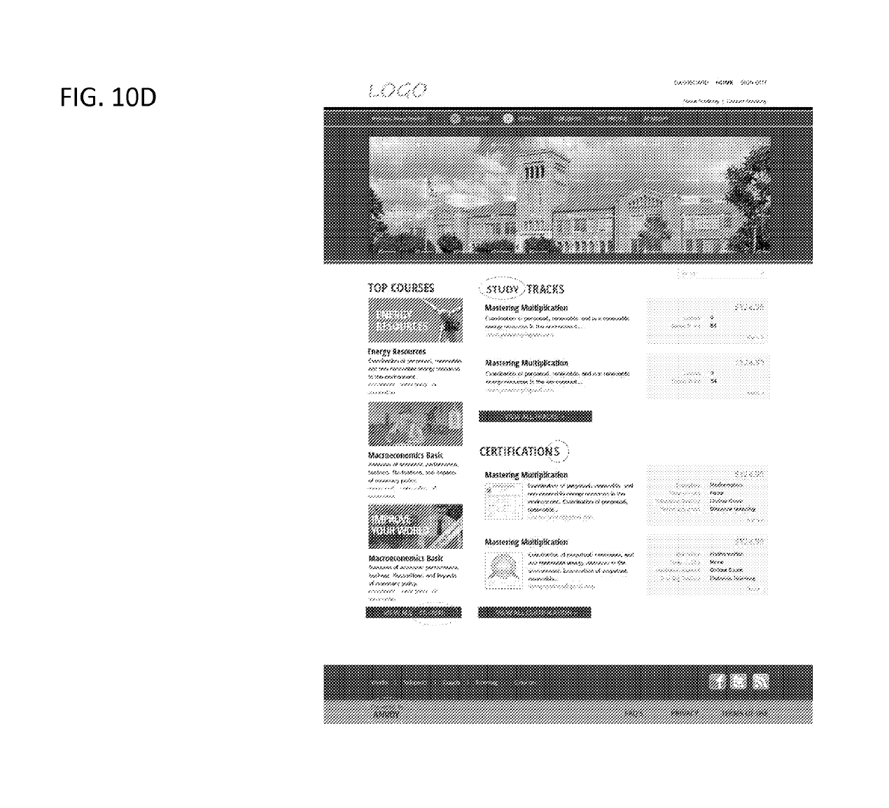

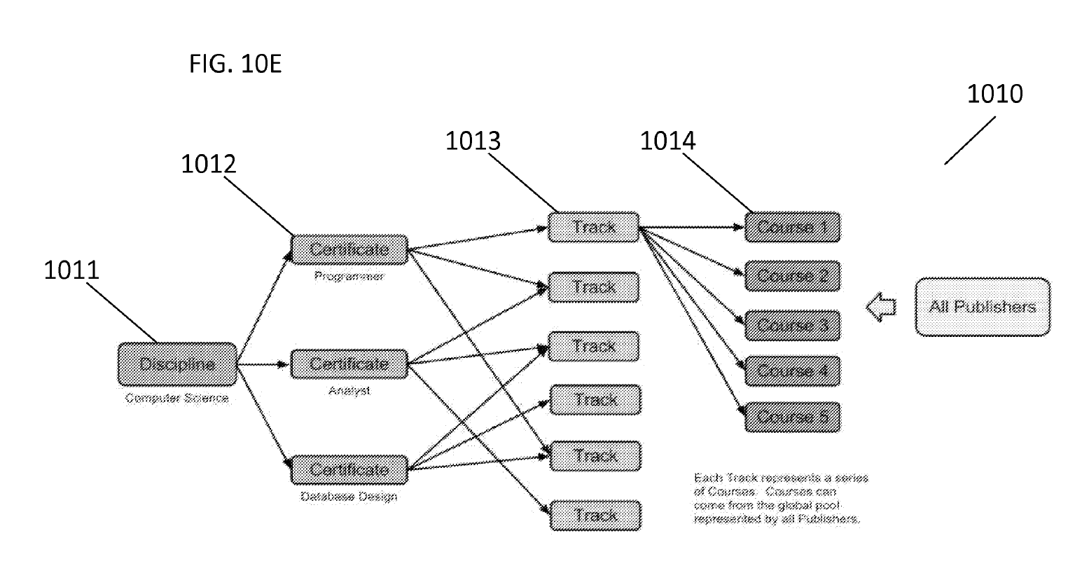

Referring now to FIG. 10A, it is shown a method 1000 for distributed online education according to at least one embodiment of the present disclosure. The method 1000 includes registering an Academy in step 1001, creating a Study Track in step 1002, registering a Student in step 10003, the Student completing the Study Track in step 1004, and the Student receiving a certification in step 1005.

In at least one embodiment of the present disclosure, the method 1000 includes registering an Academy in step 1001. As used in the present disclosure, an Academy includes, but is not limited to, an organization intending to offer one or more Courses within an e-learning application and, if applicable, certifications associated with groups of such Courses. In at least one embodiment of the present disclosure, an Academy may register with an e-learning application available on the Internet in step 1001. In such an embodiment, the e-learning application presents a user a registration page requesting information about the Academy. In such an embodiment, the user inputs information about the Academy into the registration page to register the Academy with the e-learning application.

In at least one embodiment of the present disclosure, the Academy creates a Study Track in step 1002. As used in the present disclosure, a Study Track includes, but is not limited to, a group of courses offered through a distributed online education system or method, such as, for example, through an e-learning application, where completion of the group of courses entitles certification or indication of completion. For example, a Study Track includes a set of courses that, if completed successfully, would enable the person completing the courses to claim a particular certification associated with the Study Track. In at least one embodiment of the present disclosure, a Study Track may include required courses and elective courses. In such an embodiment, completion of a Study Track may require completion of the required courses and a certain number of elective courses.

In at least one embodiment of the present disclosure, an Academy may create a Study Track through an e-learning application and offer the Study Track to Students. In the event that a particular Student completes the Study Track, the Academy may bestow an industry certification upon the particular Student. It should be appreciated that a Study Track may include a single course or any number of courses that, upon completion, would bestow a certification upon the completing Student. As used in the present disclosure, a certification includes, but is not limited to, an industry certification, professional certification, and/or academic degree. A certification may also include certain information associated with the certification, such as, for example, the name of the certification, description of the certification, a list of required Study Tracks needed to complete the certification, which independent Academy created and is associated with the certification, the cost of the certification, location of where the certification is offered, time required on an e-learning application to complete the certification, how the certification is obtained (oral, written exam, performance test, etc.), hands on training available, a discipline associated with the certification, and an Internet URL for more information about the certification.

In at least one embodiment of the present disclosure, a certification may be obtained through the completion of one Study Track, more than one Study Track, or a combination of courses and Study Tracks. It is within the scope of the present disclosure for a Study Track to apply towards the path of obtaining more than one certification. In at least one embodiment of the present disclosure, completion of Study Tracks, courses, and obtaining certifications through interaction with an Academy is stored in an Achievement Database within an e-learning system.

In at least one embodiment of the present disclosure, the completion of a single Course by a Student may indicate progress on one or multiple Study Tracks. In such an embodiment, an e-learning application may be configured to present the listing of Study Tracks that the student has progressed on by completing the course. For example, a Student completes a course titled “Algebra”. In this example, the “Algebra” course has been selected by multiple Academies for inclusion in their Study Tracks. For example, Academy A has created the Study Track “Math 1” which includes the two courses “Algebra” and “Geometry”. Academy B has created the Study Track “Math 2” which includes the two courses “Algebra” and “Algebra 2”. In this example, an e-learning application may present to the Student a window that describes the Student's completion of the course titled “Algebra” shows progress in the following Study Tracks: “Math 1”, “Math 2”. It should be appreciated that it is within the scope of the present disclosure for the e-learning application to present various information regarding the progress of Study Tracks by a Student completing courses within an e-learning system. For example, the e-learning application may present a percentage completion of a Study Track to a Student, the certifications available to the Student by completing the listed Study Tracks, Coaches the Student has already worked with who are teaching courses along the listed Study Tracks, and other information.

In at least one embodiment of the present disclosure, the Academy may offer the Study Track through an e-learning application, such as, for example, through a web portal as shown in FIGS. 10B and 10C. In at least one embodiment of the present disclosure, a Student interested in learning more about the various Study Tracks and certifications available to be earned through Study Tracks offered by an Academy may browse through an online portal of an e-learning application, such as, for example, the online portal disclosed in FIG. 10D. In at least one embodiment of the present disclosure where the Academy is created in an e-learning application, the Academy may present itself as an independent entity from the e-learning application, such as, for example, as disclosed in FIG. 10D. It is within the scope of the present disclosure, however, for the e-learning application to provide a single login and authentication structure for the Academy and the e-learning application itself. Therefore, it is within the scope of the present disclosure for the Academy to be presented independently from the e-learning application but still connected to the e-learning application such that a Student browsing the e-learning application would use the same login credentials to browse the Study Tracks and various course offerings from the Academy.

In at least one embodiment of the present disclosure, an Academy may promote courses offered within an e-learning application and obtain a referral fee for Students purchasing such courses. It should be appreciated that the purpose of this payment is to encourage independent Academies to promote a publisher's course. It should be appreciated that an Academy may use all available courses within an e-learning application to create Study Tracks and certifications.

In at least one embodiment of the present disclosure, a Student registers to take courses along a Study Path in step 1003. In at least one embodiment of the present disclosure, an Academy may offer a Study Track for a discounted fee as opposed to the cost of the Student taking each course in the Study Track individually. In an alternative embodiment, an Academy may offer a Study Track for an additional fee, such additional fee being associated with certification obtained by the Student after completion of the Study Track. It should be appreciated that it is within the scope of the present disclosure that a Student registering for one or more courses within a Study Track in step 1003 would learn the materials in each course of the Study Track through a Coach as disclosed herein. In at least one embodiment of the present disclosure, an Academy may only allow persons to become a Coach in courses involved in a Study Track in the event that such Coach has completed the Study Track or is certified in the industry certification obtained through completion of the Study Track.

In at least one embodiment of the present disclosure, a Student completes a Study Track in step 1004. In such an embodiment, the Student completes all of the courses associated with the Study Track by a Coach evaluating the Student's performance in each course. In at least one embodiment of the present disclosure, the Student receives a certification associated with completion of the Study Track in step 1005. Referring now to FIG. 10E, it is shown a model 1010 of certification in a plurality of Study Tracks according to at least one embodiment of the present disclosure. As shown in FIG. 10E, in at least one embodiment of the present disclosure, a Student may choose a Discipline 1011 which includes one or more various certifications 1012. Through the method 1000, one or more Academies may offer Tracks 1013 associated with the certifications 1012 that the Student is interested in pursuing for his or her discipline 1011. In such an embodiment, by completing each Track 1013 as described in the method 1000 through the completion of various courses 1014, the Student may achieve the certifications 1012 necessary according to the Discipline 1011. As used in the present disclosure, a Discipline 1011 includes, but is not limited to, a grouping of one or more Study Tracks 1013 and certifications 1012.

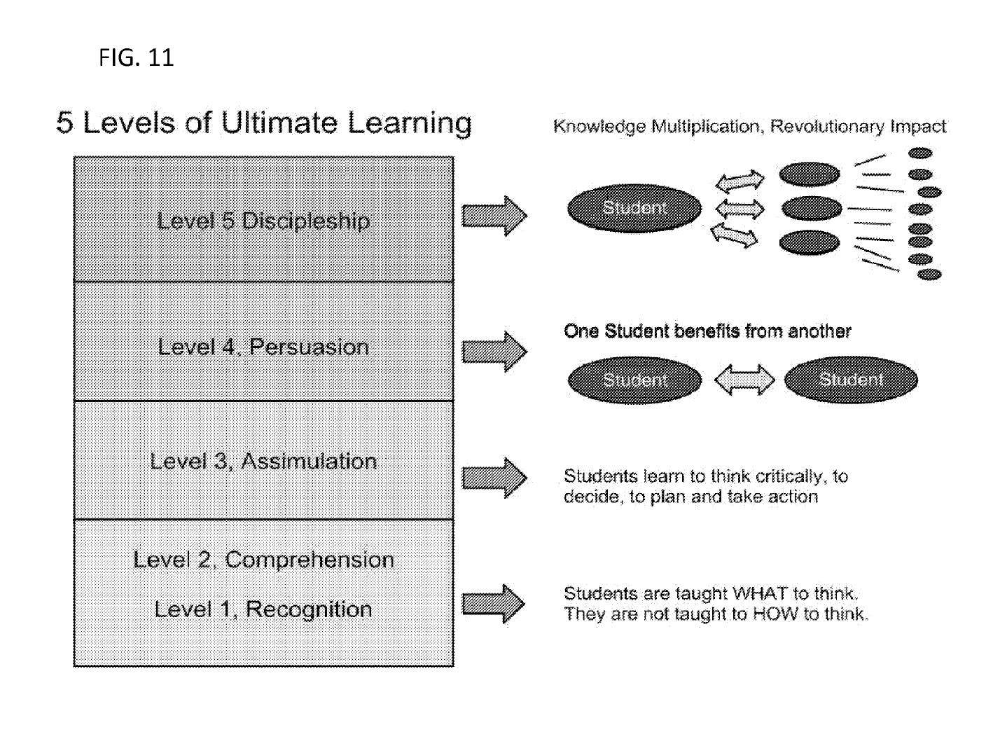

It should be appreciated that the methods, systems, and models disclosed herein may enable a Student to proceed through the 5 Levels of Ultimate Learning as shown in FIG. 11. By teaching a Student to think and encouraging peer to peer education, the systems and methods disclosed herein enable knowledge multiplication in a way that impacts an exponentially increasing amount of individuals.

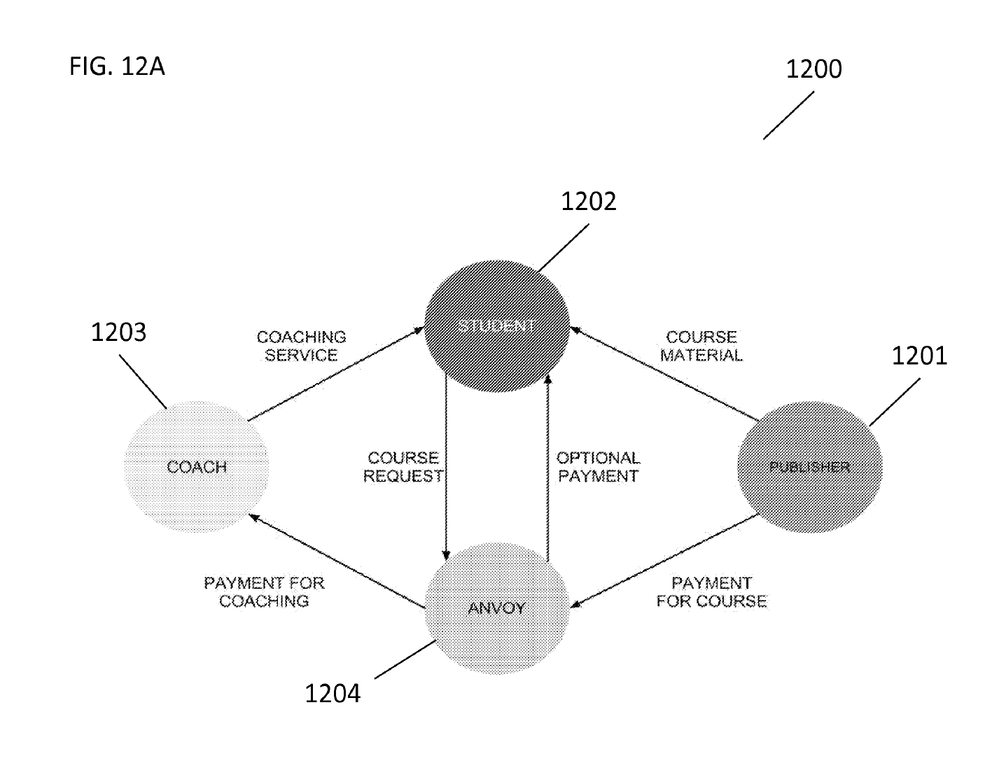

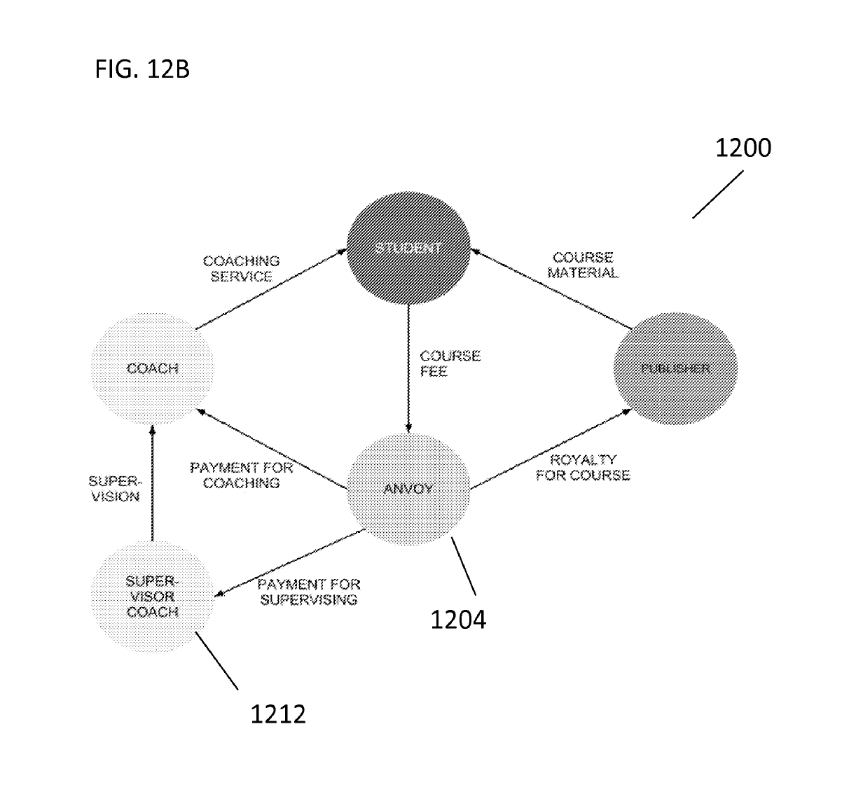

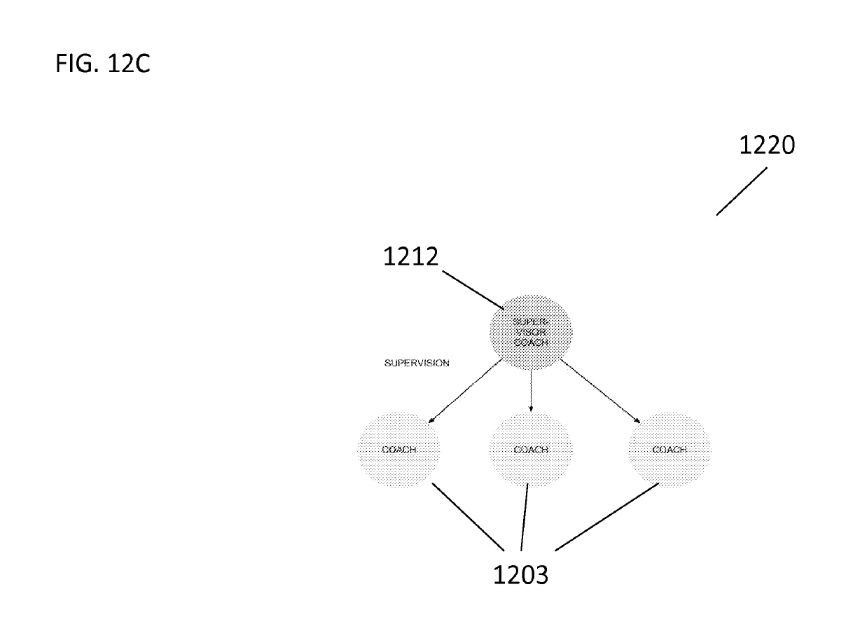

In at least one embodiment of the present disclosure, a course may be offered free to a Student and paid for by a Publisher. In such an embodiment, a Publisher may wish to offer free courses to Students to help promote the Publisher's additional courses, products, software, or other services. In such an embodiment, the Publisher may pay an e-learning application the fee associated with offering the course and the Publisher may also pay each individual Coach that teaches the course to other Students. An example of a model 1200 for payment in the event a Publisher offers a free course through an e-learning application is shown in FIG. 12A. As shown, for example, in FIG. 12A, the Publisher 1201 pays the e-learning application 1204 for every Student 1202 that takes the course. In this example, the Publisher 1201 provides course materials to the Student 1202, and the Student is taught by a Coach 1203. In this example, the e-learning application 1204 pays the Coach 1203 for teaching the Student 1202. For example, a Publisher that sells a complicated software suite may offer free online training courses through an e-learning application that follows the online distributed education system, models, and methods described herein. In this example, the Publisher creates one or more courses through the e-learning application and one or more Students sign up for such courses without paying a cost. In this example, the Publisher pays to the e-learning application a fee associated with each Student that signs up for the course and the Publisher pays each Coach that teaches the course.

It should be appreciated that courses offered for free to Students and paid for by a Publisher may be publicly available on an e-learning application to be selected by Students or may be privately offered to a set of Students. In at least one embodiment of the present disclosure, when the courses are privately offered, the Publisher may choose to offer the course to Students that fit certain demographic criteria, such as, for example, geographic location, age, sex, college major, language, or others. In another embodiment, the Publisher may choose to offer the course to Students who have purchased the Publisher's products or services and have a need to take the course in order to learn how to use the products or get the most out of the provided services.

In at least one embodiment of the present disclosure, a supervised course may be offered to a Student. In such an embodiment, a supervised course includes an additional supervisor to oversee the teaching of the Coach. It should be appreciated that a supervised course is generally available for more complicated subjects which require more training for Coaches. As shown, for example, in FIG. 12B, the Supervisor Coach 1212 is added in the model 1200 and provides supervision to the Coach. In such a model, the e-learning application 1204 pays the Supervisor Coach 1212 for providing the supervision to the Coach. It should be appreciated that a supervisor may work with multiple Coaches. For example, referring now to FIG. 12C, a model 1220 for distributed online education is shown. As shown, for example, in FIG. 12C, the Supervisor Coach 1212 supervises multiple Coaches 1203. It should be appreciated that the fees associated with providing coaching services and supervision services is configurable by the e-learning application and/or the Publisher.

It should be appreciated that the methods, systems, and models disclosed herein may enable common pages to be added to courses. These common pages are maintained at the Publisher level. For example, publishers may decide to start every course with the same opening page and end with the same closing page. As such, a Publisher may maintain one version of these common pages and easily add them to multiple courses.

In at least one embodiment of the present disclosure, courses may be rated for difficulty. A Publisher and/or an e-learning application may rate a course based on difficulty and assign an appropriate target age group. For example, a Publisher may choose an appropriate age range between ages five to thirty as indicators of the approximate level of the course. For example, a Publisher offering a course intended for elementary students may choose the age range of five to twelve. In another example, a Publisher offering a course to students at the college level may choose an age range between 19 and 22. It should be appreciated that varying age ranges are configurable and a Publisher may choose to include an age range or not include an age range.

In at least one embodiment of the present disclosure, a Student will rate the accuracy of the difficult score. In such an embodiment, the feedback provided will alter the rating of the course and/or indicate to the Publisher that the rating should be reviewed.

In at least one embodiment of the present disclosure, the methods and models described herein may be implemented in a computer system presented as an e-learning application available on the Internet. In such an embodiment, the e-learning application is distributed as the application layer of a server and network based infrastructure. In such an embodiment, the Achievement Database may be stored within a common relational database, such as, for example, Oracle, mysql, MSSQL, and others. In such an embodiment, the e-learning application may be written in C++, C#, Asp.NET, Perl, Python, PHP, or other programming and language and be presented through web services that are electronically coupled to the Achievement database. In such an embodiment, the models and methods described herein may be features and/or components of the e-learning application.

Those skilled in the art will recognize that numerous modifications can be made to the specific implementations described above. Therefore, the subject matter of this disclosure is not to be limited to the specific embodiments illustrated and described above. The systems and methods described above may be amended to encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method for online distributed education comprising:
receiving a course materials from a teacher;
publishing a course based on the course materials to a plurality of students;
receiving at least one registration from a first student in the plurality of students to the course;
the teacher teaching the course to the first student;
the first student completing the course; and
the first student teaching the course to at least one student in the plurality of students.

2. The method of claim 1, wherein the at least one student in the plurality of students pays a first fee to the first student for teaching the course, a second fee to the teacher for publishing the course, and a third fee to a party that promoted the course, wherein such party is selected from one of the first student, an academy, or a second student.

3. The method of claim 1, further comprising:
the first student submitting feedback about the course and the teaching of the teacher; and
the at least one student submitting feedback about the course and the teaching of the first student.

4. The method of claim 1, further comprising, the first student submitting a first payment to a course creator to purchase the course materials.

5. The method of claim 4, further comprising:
the second student submitting a second payment to the first student to purchase the course materials at the processor;
the first student submitting a first royalty payment to the course creator;
and the first student submitting a sales commission to a party that promoted the course.

6. The method of claim 1, further comprising:
the at least one student completing the course; and
the at least one student teaching the course to a second student in the plurality of students.

7. The method of claim 1, further comprising:
receiving a second course materials from a second teacher;
publishing a second course based on the second course materials to the plurality of students;
receiving at least one registration from the first student to the second course;
the second teacher teaching the second course to the first student;
the first student completing the second course; and
the first student teaching the second course to at least one student in the plurality of students.

8. The method of claim 7 further comprising:
associating the first course and the second course with a study path; and
bestowing a certification to the first student for completing the study path.

9. A system for online distributed education, the system comprising:
an achievement database, the achievement database configured to store a student information, wherein the student information is associated a student;
a server electronically coupled to the achievement database, the server configured to publish one or more courses and the student information;
the first server electronically coupled to a student device, the server configured to interact with the student to present the student information and the one or more courses; and
the first server electronically coupled to a teacher device and the student device, the first server configured to communicate with the student device and teacher device to aid the teacher to teach the one or more courses.

10. The system of claim 9 wherein the student information includes at least one of completed courses, completed study paths, obtained certifications, personal information, progress report, and/or an achievement certificate.

11. A method for online distributed education comprising:
receiving a plurality of course materials associated with a plurality of courses;
assigning a study track, wherein the study track requires successful completion of each of the plurality of courses;
publishing the study track in an e-learning application;
a student registering for the study track;
at least one teacher teaching each of the plurality of courses to the student;
the student completing each of the plurality of courses; and
bestowing a certificate to the student for completion of the study track.

12. The method of claim 11, further comprising:
the student teaching at least one course in the plurality of courses to a second student.

13. The method of claim 12, further comprising:
the second student paying the student a fee for teaching the at least one course;
the student paying a portion of the fee to the publisher of the at least one course; and
the student paying a portion of the fee to a party promoting the course.

14. The method of claim 11, further comprising:
assigning a second study track, wherein the second study track requires successful completion of a portion of the plurality of courses.

15. The method of claim 14, further comprising:
bestowing a second certificate to the student for completion of the second study track.

16. A system for online distributed education comprising:
an e-learning server electronically coupled to a plurality of user devices;
data stored in a memory indicative of a course materials;
wherein the e-learning server is configured to receive payment for the course materials from the plurality of user devices and to publish the course materials to the plurality of user devices that submitted the payment; and
the e-learning server electronically coupled to a first user device in the plurality of user devices, wherein the e-learning server is configured to present the course materials to the first user device.

17. The system of claim 16, further comprising:
a second user device in the plurality of user devices operably connected to the first user device, wherein the second user device is configured to access the course materials and communicate with the second user device; and
wherein the first user device and second user device communicate to teach the course materials to a user of the second user device.

18. The system of claim 17, wherein the e-learning server is electronically coupled to the Internet.

19. The system of claim 17, wherein the e-learning server is configured to send a portion of the payment received for the course materials to the first user device.

20. The system of claim 16, further comprising a database electronically coupled to the e-learning server, wherein the database is configured to store the course materials, the payment, and a registration information for a user associated with the first user device

21. The system of claim 17, further comprising:
wherein the e-learning server is configured to receive a feedback from the user about the course materials;
a database electronically coupled to the e-learning server, wherein the database is configured to store the course materials and the feedback.
